(19) United States
(12) Patent Application Publication
(10) Pub. No.: US 2026/0169296 A1
(43) Pub. Date: Jun. 18, 2026

(54) METHODS, APPARATUSES AND COMPUTER PROGRAM PRODUCTS FOR GAZE REFINED OBJECT DETECTION IN AN ENVIRONMENT

(71) Applicant: Meta Platforms, Inc., Menlo Park, CA (US)

(72) Inventors: David Frederick Geisert, London (GB); Hayden Schoen, Evanston, IL (US)

(21) Appl. No.: 19/425,946

(22) Filed: Dec. 18, 2025

Related U.S. Application Data
(60) Provisional application No. 63/735,655, filed on Dec. 18, 2024.

(51) Int. Cl. G02B 27/01; G02B 27/00; G06F 3/01; G06V 20/20

(52) U.S. Cl. CPC G02B 27/0172; G02B 27/0093; G06F 3/013; G06V 20/20

(57) ABSTRACT

A system and method to facilitate analysis of an object of interest based on a gaze are provided. The system may determine a gaze of an eye of a user based on the user viewing, by a communication device, content items in an environment. The system may capture a first image of an object of interest to the user from among the content items in the environment. The system may generate a bounding region around the object of interest. The system may remove, by a machine learning model, items of data associated with objects other than the object of interest from the bounding region to generate a second image. The system may determine, based on the removing of the items of data, items of information about the object of interest.

### CROSS-REFERENCE TO RELATED APPLICATIONS

This application claims priority to U.S. Provisional Application No. 63/735,655, filed Dec. 18, 2024, entitled “Methods, Apparatuses And Computer Program Products For Gaze Refined Object Detection In An Environment,” which is incorporated by reference herein in its entirety.

### TECHNOLOGICAL FIELD

Exemplary embodiments of this disclosure relate generally to methods, apparatuses, computer program products to utilize eye tracking and/or determinations of a gaze(s) of users to detect an object(s) within content captured within a field of view of a device.

### BACKGROUND

Artificial reality (AR) is a form of reality that has been adjusted in some manner before presentation to a user, which may include, for example, a virtual reality (VR), an augmented reality (AR), a mixed reality (MR), a hybrid reality (HR), or some combination or derivative thereof. Artificial reality content may include completely computer-generated content or computer-generated content combined with captured (e.g., real-world) content. The artificial reality content may include video, audio, haptic feedback, or some combination thereof, any of which may be presented by a single channel or by multiple channels (such as stereo video that produces a three-dimensional (3D) effect to the viewer).

Captured content may include content captured by a camera on an artificial reality device. The camera may take a portion of the camera field of view and present content based on the user's head position. The presented content, based on the user's field of view may be presented to an artificial intelligence model that may answer a question about a picture captured by the camera. This mechanism utilized by some existing systems may lead to information being presented about objects in the picture that may be of no interest to the user. For instance, there may be capture of irrelevant background objects in the picture that may not be interesting to the user.

### BRIEF SUMMARY

Various systems, methods, and devices are described herein for generating an image(s) of an object(s), based on a user's gaze, within the field of view of a head-mounted display/device, an artificial reality system, and/or smart glasses, or other visual sensors associated with AR systems, virtual reality systems, and/or mixed reality systems for analysis. In some examples, the image may be sent to a multimodal artificial intelligence (MMAI) system that may answer questions about an object(s) in the image. In some examples, generating the image within the sensor field of view may include cropping a captured image of the sensor field of view to include the object(s) that may be the focus of the user's gaze. In other examples, generating the image within the sensor field of view may include segmenting and clipping an object(s) from the captured image of the sensor field of view so that a new image or updated image may include the object that is the focus of the user's gaze over a background distinct from the object.

The present disclosure may provide systems and methods for a gaze analysis model in association with the gaze of a user(s). In various examples, systems and methods may receive data indicating an object(s) of interest displayed in a device (e.g., an AR device). In this regard, gazes, pupil dilations, and/or muscle movements of a user(s) may be determined in relation to displayed content to the user(s) to determine the object(s) of interest via an eye tracking system and/or face tracking system. Based on the observed gaze of users focused on a content item(s) being displayed, a captured image indicated in the sensor field of view may be edited to display a cropped view of the object(s) of interest or clipping of the object(s) of interest via machine learning models that may respond to prompts about the object(s) of interest.

In one example of the present disclosure, a method is provided. The method may include determining a gaze of an eye of a user based on the user viewing, by a communication device, content items in an environment. The method may further include capturing a first image of an object of interest to the user from among the content items in the environment. The method may further include generating a bounding region around the object of interest. The method may further include removing, by a machine learning model, items of data associated with objects other than the object of interest from the bounding region to generate a second image. The method may further include determining, based on the removing of the items of data, items of information about the object of interest.

In another example of the present disclosure, an apparatus is provided. The apparatus may include one or more processors and a memory including computer program code instructions. The memory and computer program code instructions are configured to, with at least one of the processors, cause the apparatus to at least perform operations including determining a gaze of an eye of a user based on the user viewing, by the apparatus, content items in an environment. The memory and computer program code are also configured to, with the processor(s), cause the apparatus to capture a first image of an object of interest to the user from among the content items in the environment. The memory and computer program code are also configured to, with the processor(s), cause the apparatus to generate a bounding region around the object of interest. The memory and computer program code are also configured to, with the processor(s), cause the apparatus to remove, by a machine learning model, items of data associated with objects other than the object of interest from the bounding region to generate a second image. The memory and computer program code are also configured to, with the processor(s), cause the apparatus to determine, based on the removing of the items of data, items of information about the object of interest.

In yet another example of the present disclosure, a computer program product is provided. The computer program product may include at least one non-transitory computer-readable medium including computer-executable program code instructions stored therein. The computer-executable program code instructions may include program code instructions configured to determine a gaze of an eye of a user based on the user viewing, by a communication device, content items in an environment. The computer program product may further include program code instructions configured to capture a first image of an object of interest to the user from among the content items in the environment. The computer program product may further include program code instructions configured to generate a bounding region around the object of interest. The computer program product may further include program code instructions configured to remove, by a machine learning model, items of data associated with objects other than the object of interest from the bounding region to generate a second image. The computer program product may further include program code instructions configured to determine, based on the removing of the items of data, items of information about the object of interest.

In one example aspect of the present disclosure, a method is provided. The method may include implementing a machine learning model including data pre-trained, or trained in real-time based on captured content or prestored content associated with one or more gazes of one or more users, one or more pupil dilations of the one or more users, facial expressions of the one or more users determined previously or in real time. The method may include determining at least one of a gaze of an eye(s) of a user associated with the user viewing, by an apparatus, one or more items of content in an environment. The environment may be a real-world environment. The method may include determining, based on the determined at least one gaze, at least one object of interest of the user based on content in the environment. The method may include generating, by implementing the machine learning model and based on the determined at least one object of interest of the user, a bounding region around an object(s) of interest based on content being viewed in the environment. The method may further include generating, by implementing the machine learning model, an image of the content inside the bounding region around an object(s) of interest based on content being viewed in the environment. The method may further include analyzing, by implementing a machine learning model, the content of an image inside a bounding region around an object(s) of interest based on content in the environment.

In another example aspect of the present disclosure, another method is provided. The method may include implementing a machine learning model including data pre-trained, or trained in real-time based on captured content or prestored content associated with one or more gazes or one or more users, one or more pupil dilations of the one or more users, facial expressions of the one or more users determined previously or in real time. The method may include determining at least one of a gaze of an eye of a user associated with a user viewing, by an apparatus, one or more items of content in an environment. The environment may be a real-world environment. The method may include determining, based on the determined at least one gaze, at least one object(s) of interest of the user based on content in the environment. The method may include generating, by implementing the machine learning model and based on the determined at least one object of interest of the user, a bounding region around the object(s) of interest based on content being viewed in the environment. The method may further include generating, by implementing the machine learning model and based on the determined at least one object of interest of the user, a segmentation mask of the object(s) of interest in the bounding region around the object(s) based on content in the environment. The method may further include generating, by the machine learning model and based on the determined at least one object(s) of interest of the user, an image of the content of the segmentation mask of an object(s) of interest based on content in the environment. The method may include analyzing, by implementing a machine learning model, the content of an image of content of a segmentation mask of an object(s) of interest based on content in the environment.

In another example aspect of the present disclosure, an apparatus is provided. The apparatus may include one or more processors and a memory including computer program code instructions. The memory and computer program code instructions are configured to, with at least one of the processors, cause the apparatus to at least perform operations including implementing a machine learning model including training data pre-trained, or trained in real-time based on captured content and/or prestored content associated with one or more gazes or more or more users, one or more pupil dilations of the one or more users, facial expressions of the one or more users determined previously or in real time. The memory and computer program code are also configured to, with the processor(s), cause the apparatus to determine at least one of a gaze of an eye of a user associated with the user viewing, by the apparatus, one or more items of content in an environment. The memory and computer program code may also be configured to, with the processor(s), cause the apparatus to determine, based on the determined at least one gaze, at least one object(s) of interest of the user based on content in the environment. The memory and computer program code are also configured to, with the processor(s), cause the apparatus to generate, by implementing the machine learning model and based on the determined at least one object(s) of interest of the user, a bounding region around the object(s) of interest based on content being viewed in the environment. The memory and computer code are also configured to, with the processor, cause the apparatus to generate, by implementing the machine learning model, an image of the content inside a bounding region around an object(s) of interest based on content being viewed in the environment. The memory and computer code are also configured to, with the processor, cause the apparatus to analyze, by implementing a machine learning model, the content of an image of content inside the bounding region around an object(s) of interest based on content in the environment.

In yet another example aspect of the present disclosure, a computer program product is provided. The computer program product may include at least one non-transitory computer-readable medium including computer-executable program code instructions stored therein. The computer-executable program code instructions may include program code instructions configured to implement a machine learning model including training data pre-trained, or trained in real-time based on captured content and/or prestored content associated with one or more gazes or more or more users, one or more pupil dilations of the one or more users, facial expressions of the one or more users determined previously or in real time. The computer program product may further include program code instructions configured to determine at least one of a gaze of an eye of a user associated with the user viewing, by the apparatus, one or more items of content in an environment. The computer program product may further include program code instructions configured to determine, based on the determined at least one gaze, at least one object(s) of interest of the user based on content in the environment. The computer program product may further include program code instructions configured to generate, by implementing the machine learning model and based on the determined at least one object(s) of interest of the user, a bounding region around the object(s) of interest based on content being viewed in the environment. The computer program product may further include program code instructions configured to generate, by implementing the machine learning model, an image of the content inside a bounding region around an object(s) of interest based on content being viewed in an environment. The computer program product may further include program code instructions configured to analyze, by implementing a machine learning model, the content of an image inside the bounding region around an object(s) of interest based on content in the environment.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4 illustrates an example of an artificial reality system comprising a headset, in accordance with an example of the present disclosure.

FIG. 5 illustrates another artificial reality system comprising a headset, in accordance with an example of the present disclosure.

FIG. 6 is an illustrative side view of a user using an AR device, in accordance with an example of the present disclosure.

FIG. 7 illustrates an example flowchart illustrating operations to isolate or detect an object within an environment by cropping, according to an example of the present disclosure.

FIG. 8 illustrates an example flowchart illustrating operations to isolate or detect an object within an environment by segmentation according to an example of the present disclosure.

FIG. 9 illustrates an example of a machine learning framework in accordance with one or more examples of the present disclosure.

FIG. 10A is a diagram of an exemplary environment that may be viewed using a device in accordance with exemplary aspects of the present disclosure.

FIG. 10B is a diagram of an exemplary environment that may be viewed using a device with an exemplary bounding region around an object of interest that may be generated by a gaze analysis component in accordance with exemplary aspects of the present disclosure.

FIG. 10C is a diagram of an exemplary cropped image of an environment created by a device in accordance with exemplary aspects of the present disclosure.

FIG. 11A is a diagram of an exemplary environment that may be viewed using a device with an exemplary bounding region and segmentation mask that may be generated by a gaze analysis component in accordance with exemplary aspects of the present disclosure.

FIG. 11B is a diagram of an exemplary segmented image of an object of interest viewed in an environment using a device in accordance with exemplary aspects of the present disclosure.

FIG. 12A is a diagram of an exemplary image of an environment that may be viewed using a device with an exemplary description of the image in accordance with exemplary aspects of the present disclosure.

FIG. 12B is a diagram of an exemplary image of the content of a bounding region around an object of interest included in an environment that may be viewed using a device in accordance with exemplary aspects of the present disclosure.

FIG. 12C is a diagram illustrating an image of the content of a segmentation mask of an object of interest included in a bounding region around an object of interest included in an environment that may be viewed using a device in accordance with exemplary aspects of the present disclosure.

FIG. 13 is a diagram of an exemplary environment in accordance with exemplary aspects of the present disclosure.

FIG. 14 illustrates content presented by a display of a head-mounted display in response to a capture of an object of interest in an environment in accordance with examples of the present disclosure.

FIG. 15 illustrates an example flowchart illustrating operations of a process in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some examples of the present disclosure will now be described more fully hereinafter with reference to the accompanying drawings, in which some, but not all examples of the disclosure are shown. Indeed, various examples of the disclosure may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary”, as used herein, is not provided to convey any qualitative assessment, but instead merely to convey an illustration of an example. Thus, use of any such terms should not be taken to limit the spirit and scope of examples of the disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein, a gaze(s), or gaze(s) of an eye of a user(s) may refer to the direction in which the eyes of a user(s) may be focused. This may include both the specific point that the eyes are looking at (e.g., a fixation point) and the movement of the eyes as they shift focus from one point to another point (e.g., saccades).

As referred to herein, a pupil dilation(s), or pupil dilation(s) of an eye(s) of a user(s) may refer to a variation in a size of a pupil(s), which may be the opening in a center of an iris of the eye(s) that may regulate the amount of light entering the eye(s).

As referred to herein, a segmentation mask may be a specific portion of an image(s) and/or video(s) that may be isolated from other portions (e.g., remaining portions) of the image(s) and/or video(s).

It is to be understood that the methods and systems described herein are not limited to specific methods, specific components, or to particular implementations. It is also to be understood that the terminology used herein is for the purpose of describing particular embodiments only and is not intended to be limiting.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

### Exemplary System Architecture

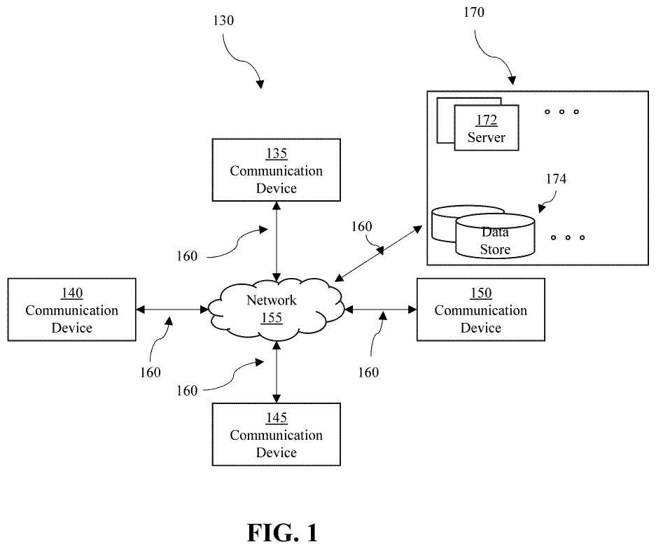

Reference is now made to FIG. 1, which is a block diagram of a system according to exemplary embodiments. As shown in FIG. 1, the system 130 may include one or more communication devices 135, 140, 145 and 150 and a network device 170. Additionally, the system 130 may include any suitable network such as, for example, network 155. In some examples, the network 155 may be a Metaverse network. In other examples, the network 155 may be any suitable network capable of provisioning content and/or facilitating communications among entities within, or associated with the network. As an example and not by way of limitation, one or more portions of network 155 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 155 may include one or more networks 155.

Links 160 may connect the communication devices 135, 140, 145 and 150 to network 155, network device 170 and/or to each other. This disclosure contemplates any suitable links 160. In some exemplary embodiments, one or more links 160 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 160 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 160, or a combination of two or more such links 160. Links 160 need not necessarily be the same throughout system 130. One or more first links 160 may differ in one or more respects from one or more second links 160.

Links 160 may connect the communication devices 135, 140, 145 and 150 to network 155, network device 170 and/or to each other. This disclosure contemplates any suitable links 160. In some exemplary embodiments, one or more links 160 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 160 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 160, or a combination of two or more such links 160. Links 160 need not necessarily be the same throughout system 130. One or more first links 160 may differ in one or more respects from one or more second links 160.

Network device 170 may be accessed by the other components of system 130 either directly or via network 155. As an example and not by way of limitation, communication devices 135, 140, 145, 150 may access network device 170 using a web browser or a native application associated with network device 170 (e.g., a mobile social-networking application, a messaging application, another suitable application, or any combination thereof) either directly or via network 155. In particular exemplary embodiments, network device 170 may include one or more servers 172. Each server 172 may be a unitary server or a distributed server spanning multiple computers or multiple datacenters. Servers 172 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 172 may include hardware, software, or embedded logic components or a combination of two or more such components for carrying out the appropriate functionalities implemented and/or supported by server 172. In particular exemplary embodiments, network device 170 may include one or more data stores 174. Data stores 174 may be used to store various types of information. In particular exemplary embodiments, the information stored in data stores 174 may be organized according to specific data structures. In particular exemplary embodiments, each data store 174 may be a relational, columnar, correlation, or other suitable database. Although this disclosure describes or illustrates particular types of databases, this disclosure contemplates any suitable types of databases. Particular exemplary embodiments may provide interfaces that enable communication devices 135, 140, 145, 150 and/or another system (e.g., a third-party system) to manage, retrieve, modify, add, or delete, the information stored in data store 174.

Network device 170 may provide users of the system 130 the ability to communicate and interact with other users. In particular exemplary embodiments, network device 170 may provide users with the ability to take actions on various types of items or objects, supported by network device 170. In particular exemplary embodiments, network device 170 may be capable of linking a variety of entities. As an example and not by way of limitation, network device 170 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 170 and four communication devices 135, 140, 145 and 150, any suitable number of network devices 170 and communication devices 135, 140, 145 and 150 may be part of the system of FIG. 1 without departing from the spirit and scope of the present disclosure.

### Exemplary Communication Device

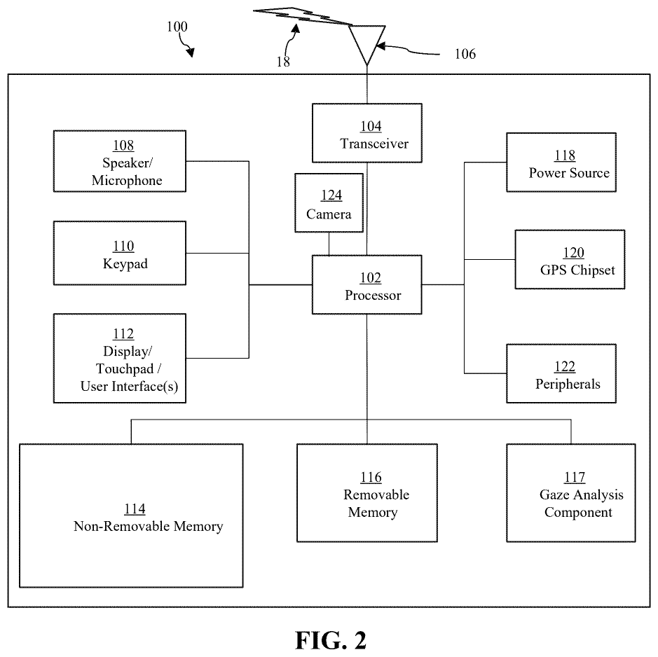

FIG. 2 illustrates a block diagram of an exemplary hardware/software architecture of a communication device such as, for example, user equipment (UE) 100. In some exemplary aspects, the UE 100 may be any of communication devices 135, 140, 145, 150. In some exemplary aspects, the UE 100 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, a head-mounted display/device (e.g., a headset), smart watch, charging case, or any other suitable electronic device. As shown in FIG. 2, the UE 100 (also referred to herein as node 100) may include a processor 102, non-removable memory 114, removable memory 116, a speaker/microphone 108, a keypad 110, a display, touchpad, and/or user interface(s) 112, a power source 118, a global positioning system (GPS) chipset 120, and other peripherals 122. In some exemplary aspects, the display, touchpad, and/or user interface(s) 112 may be referred to herein as display/touchpad/user interface(s) 112. The display/touchpad/user interface(s) 112 may include a user interface capable of presenting one or more content items and/or capturing input of one or more user interactions/actions associated with the user interface. The power source 118 may be capable of receiving electric power for supplying electric power to the UE 100. For example, the power source 118 may include an alternating current to direct current (AC-to-DC) converter allowing the power source 118 to be connected/plugged to an AC electrical receptable and/or Universal Serial Bus (USB) port for receiving electric power. The UE 100 may also include a camera 124. In an exemplary embodiment, the camera 124 may be a smart camera configured to detect/capture images/videos in a field of view. In some example aspects, the detected/captured images may appear/be viewed within one or more bounding boxes. The UE 100 may also include communication circuitry, such as a transceiver 104 and a transmit/receive element 106. It will be appreciated the UE 100 may include any sub-combination of the foregoing elements while remaining consistent with an embodiment.

The processor 102 is coupled to its communication circuitry (e.g., transceiver 104 and transmit/receive element 106). The processor 102, through the execution of computer executable instructions, may control the communication circuitry in order to cause the node 100 to communicate with other nodes via the network to which it is connected.

The transmit/receive element 106 may be configured to transmit signals to, or receive signals from, other nodes or networking equipment. For example, in an exemplary embodiment, the transmit/receive element 106 may be an antenna configured to transmit and/or receive radio frequency (RF) signals. The transmit/receive element 106 may support various networks and air interfaces, such as wireless local area network (WLAN), wireless personal area network (WPAN), cellular, and the like. In yet another exemplary embodiment, the transmit/receive element 106 may be configured to transmit and/or receive both RF and light signals. It will be appreciated that the transmit/receive element 106 may be configured to transmit and/or receive any combination of wireless or wired signals.

The transceiver 104 may be configured to modulate the signals that are to be transmitted by the transmit/receive element 106 and to demodulate the signals that are received by the transmit/receive element 106. As noted above, the node 100 may have multi-mode capabilities. Thus, the transceiver 104 may include multiple transceivers for enabling the node 100 to communicate via multiple radio access technologies (RATs), such as universal terrestrial radio access (UTRA) and Institute of Electrical and Electronics Engineers (IEEE 802.11), for example.

The processor 102 may access information from, and store data in, any type of suitable memory, such as the non-removable memory 114 and/or the removable memory 116. For example, the processor 102 may store session context in its memory, (e.g., non-removable memory 114 and/or removable memory 116) as described above. The non-removable memory 114 may include RAM, ROM, a hard disk, or any other type of memory storage device. The removable memory 116 may include a subscriber identity module (SIM) card, a memory stick, a secure digital (SD) memory card, and the like. In other exemplary embodiments, the processor 102 may access information from, and store data in, memory that is not physically located on the node 100, such as on a server or a home computer.

The processor 102 may receive power from the power source 118, and may be configured to distribute and/or control the power to the other components in the node 100. The power source 118 may be any suitable device for powering the node 100. For example, the power source 118 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 102 may also be coupled to the GPS chipset 120, which may be configured to provide location information (e.g., longitude and latitude) regarding the current location of the node 100. It will be appreciated that the node 100 may acquire location information by way of any suitable location-determination method while remaining consistent with an exemplary embodiment.

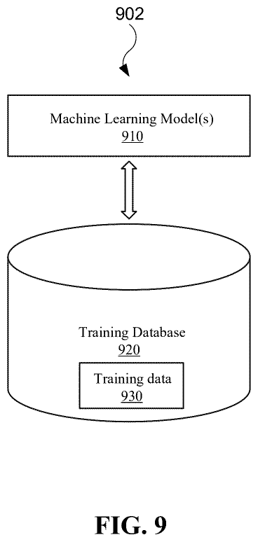

The UE 100 may further include a gaze analysis component 117 that may isolate an object of interest in an environment from the environment viewed by a user to create an image for analysis, based in part on determining at least one of a gaze of one more eyes of a user, facial expressions, facial features of a user(s) and/or the like, as described more fully below. In some examples, the gaze analysis component 117 may implement a machine learning model (e.g., machine learning model(s) 910 of FIG. 9) and/or an artificial intelligence (AI) model that may be pre-trained, trained in real-time, and/or periodically trained with training data (e.g., training data 930 of FIG. 9) to enable detection and/or isolation of an object of interest in an environment based on the environment viewed by a user (e.g., captured via the camera) to generate/create an image for analysis based in part on determining at least one of a gaze(s) of one more eyes of a user, facial expressions, facial features of a user(s) and/or the like, as described more fully below.

In some examples, the gaze analysis component 117 may include, or be associated with, a multimodal artificial intelligence (MMAI) model configured to receive voice input, text input, images, and/or videos and may provide information pertaining to input information (e.g., the voice input, text input, images, and/or videos). In some examples, the image may be sent via a network (e.g., network 155) to another device (e.g., UE 100, communication device 135, communication device 140, communication device 145, communication device 150, network device 170, computing system 300, artificial reality system 400, head-mounted display (HMD) 500) containing a gaze analysis component (e.g., gaze analysis component 117, gaze analysis component 313, or gaze analysis component 407) to facilitate analysis of the image. In some examples, the gaze analysis component 117 may be included, or associated with another device (e.g., a server, HMD 500, etc.) external or remote to the UE 100.

### Exemplary Computing System

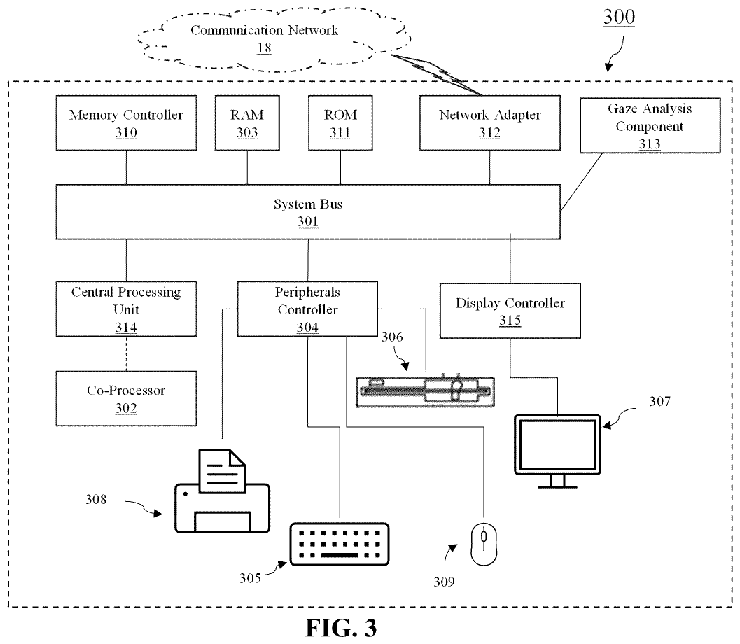

FIG. 3 is a block diagram of an exemplary computing system 300. In some exemplary embodiments, the network device 170 may be a computing system 300. The computing system 300 may include a gaze analysis component 313. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 314, to cause computing system 300 to operate. In many workstations, servers, and personal computers, central processing unit 314 may be implemented by a single-chip CPU called a microprocessor. In other machines, the central processing unit 314 may comprise multiple processors. Coprocessor 302 may be an optional processor, distinct from main CPU 314, that performs additional functions or assists CPU 314.

In operation, CPU 314 fetches, decodes, and executes instructions, and transfers information to and from other resources via the computer's main data-transfer path, system bus 301. Such a system bus connects the components in computing system 300 and defines the medium for data exchange. System bus 301 typically includes data lines for sending data, address lines for sending addresses, and control lines for sending interrupts and for operating the system bus. An example of such a system bus 301 is the Peripheral Component Interconnect (PCI) bus.

Memories coupled to system bus 301 include RAM 303 and ROM 311. Such memories may include circuitry that allows information to be stored and retrieved. ROMs 311 generally contain stored data that cannot easily be modified. Data stored in RAM 303 may be read or changed by CPU 314 or other hardware devices. Access to RAM 303 and/or ROM 311 may be controlled by memory controller 310. Memory controller 310 may provide an address translation function that translates virtual addresses into physical addresses as instructions are executed. Memory controller 310 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 304 responsible for communicating instructions from CPU 314 to peripherals, such as printer 308, keyboard 305, mouse 309, and disk drive 306.

Display 307, which is controlled by display controller 315, may be used to display visual output generated by computing system 300. Such visual output may include text, graphics, animated graphics, and video. The display 307 may also include, or be associated with a user interface. The user interface may be capable of presenting one or more content items and/or capturing input of one or more user interactions associated with the user interface. Display 307 may be implemented with a cathode-ray tube (CRT)-based video display, a liquid-crystal display (LCD)-based flat-panel display, gas plasma-based flat-panel display, or a touch-panel. Display controller 315 includes electronic components required to generate a video signal that is sent to display 307.

Further, computing system 300 may contain communication circuitry, such as for example a network adaptor 312, that may be used to connect computing system 300 to an external communications network, such as network 18 of FIG. 2, to enable the computing system 300 to communicate with other nodes (e.g., UE 100) of the network.

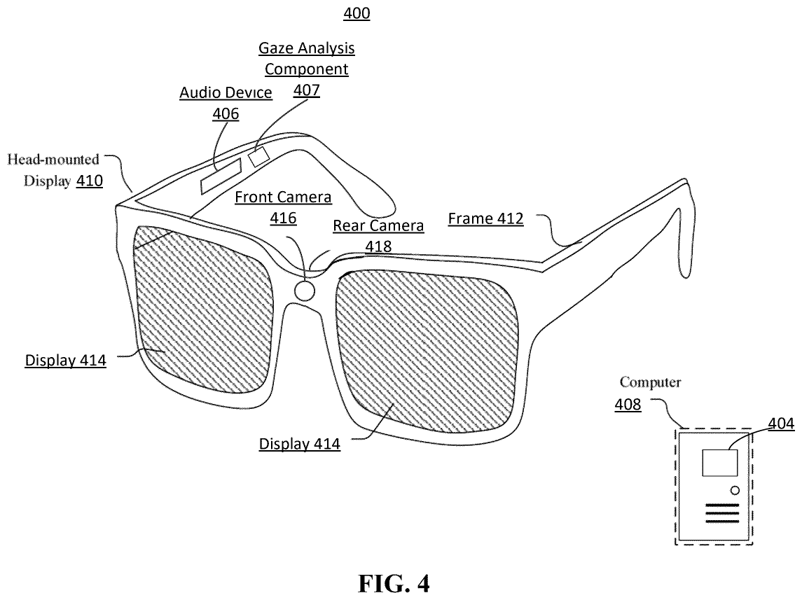

The gaze analysis component 313 may receive one or more requests to provide information about an object(s) of interest from a device (e.g., UE 100, artificial reality system 400, HMD 500 (e.g., via the gaze analysis component 117 of FIG. 2, via the gaze analysis component 407 of FIG. 4)). In response to receipt of such a request(s) from the device, the gaze analysis component 313 may determine one or more objects of interest from content (e.g., AR/VR/MR content) viewed in an environment. The gaze analysis component 313 may generate a bounding region around the object(s) of interest and may generate an image associated with the object(s) of interest inside the bounding region. Applying a bounding region may enable cropping an image to remove objects that are of no interest to a user. In some examples, bounding regions may be presented as one of many shapes (e.g., a bounding region may be a square, rectangle or other shape(s)).

The gaze analysis component 313 may provide information about the content inside the bounding region based on the one or more requests to provide information about the object(s) of interest. In some other examples, the gaze analysis component 313 may provide information about the content inside the bounding region based on detecting an object of interest associated with a determined gaze such as for example a gaze of an eye(s) of a user that lasts the duration of a predetermined threshold (e.g., 1 second, 2 seconds, etc.). In some examples, the gaze analysis component 313 may be tuned to provide a specific amount of information (e.g., the gaze analysis component may generate information about the object(s) of interest). In some examples, the gaze analysis component 313 may implement a machine learning model (e.g., machine learning model(s) 910 of FIG. 9) and/or an AI model that may be pre-trained, trained in real-time, and/or periodically trained with training data (e.g., training data 930 of FIG. 9) to identify/determine the object(s) of interest based in part on receipt of the request(s) from a device. In some examples, the gaze analysis component 313 may further generate a segmentation mask around the object(s) of interest in the bounding region. In these examples, the gaze analysis component 313 may provide information about the content inside/within the segmentation mask. By applying a segmentation mask, the gaze analysis component 313 may allow for more precise information being provided about the object(s) of interest based on the request to provide information.

In some examples, the gaze analysis component 313 may include, or be associated with, a MMAI model configured to receive voice input, text input, images and/or videos and may provide information pertaining to the input information (e.g., the voice input, text input, images and/or videos). In some examples, the MMAI model may be, or may be part of, the machine learning model(s) 910. In some examples the image may be sent via a network (e.g., network 155) to another device (e.g., UE 100, communication device 135, communication device 140, communication device 145, communication device 150, network device 170, artificial reality system 400 or HMD 500) containing a gaze analysis component (e.g., gaze analysis component 117, gaze analysis component 407) for analysis. In some examples, the gaze analysis component may be included within, or associated with another device (e.g., HMD 500) that may be external or remote to the computing system 300.

### Exemplary Artificial Reality System

FIG. 4 illustrates an example artificial reality system 400. The artificial reality system 400 may include a head-mounted display (HMD) 410 (e.g., smart glasses and/or augmented/virtual reality device) comprising a frame 412, one or more displays 414, a computing device 408 (also referred to herein as computer 408), a controller 404, and a gaze analysis component 407. In some examples, the HMD 410 may capture one or more items of text, content, or other objects from one or more images/videos associated with a real-world environment in the field of view of one or more cameras (e.g., cameras 416, 418) of the artificial reality system 400. The HMD 410 may utilize the captured text from the one or more images/videos to trigger one or more actions/functions by the artificial reality system 400. The displays 414 may be transparent or translucent allowing a user wearing the HMD 410 to look through the displays 414 to see/view the real world (e.g., real world environment) and the displays 414 may provide displaying of visual artificial reality content, and/or other content, to the user at the same time. Some examples of the content that may be displayed by the displays 414 may include, but is not limited to, text, images, videos, icons, animations, avatars and/or other graphical content. The HMD 410 may include an audio device 406 (e.g., speakers/microphones) that may provide audio artificial reality content to users. The HMD 410 may include one or more cameras 416, 418 which may capture images and/or videos of environments. In one exemplary embodiment, the HMD 410 may include one or more cameras 418 which may be a rear-facing camera(s) tracking movement and/or gaze of a user's eyes.

One of the cameras 416 may be a forward-facing camera capturing images and/or videos of the environment (e.g., a real world environment) that a user wearing the HMD 410 may view. The camera(s) 416 may also be referred to herein as a front camera(s) 416. The HMD 410 may include an eye tracking system to track the vergence movement of the user wearing the HMD 410. In one exemplary aspect, the camera(s) 418 may be the eye tracking system. In some exemplary aspects, the camera(s) 418 may be one camera configured to view at least one eye of a user to capture a glint image(s) (e.g., and/or glint signals). The camera(s) 418 may also be referred to herein as a rear camera(s) 418.

The eye tracking system within the HMD 410 may determine pupil dilation(s) by utilizing one or more cameras (e.g., camera(s) 418) and/or other sensors such as scanning systems aimed at an eye(s) of a user(s). The cameras may capture high-resolution images and/or videos of the eye(s) at frequent intervals. In some example aspects, the eye tracking system may utilize image processing applications or image processing algorithms to analyze the captured images and/or videos in real-time to facilitate determination of pupil dilation(s).

The HMD 410 may include a microphone of the audio device 406 to capture voice input from the user. The artificial reality system 400 may further include a controller 404 comprising a trackpad and one or more buttons. The controller 404 may receive inputs from users and relay the inputs to the computing device 408. The computing device 408 may include a memory device(s) (e.g., a RAM, a ROM) that may store the inputs and other data/content. The controller 404 may also provide haptic feedback to one or more users. The computing device 408 may be connected to the HMD 410 and the controller 404 through cables or wireless connections. The computing device 408 may control the HMD 410 and the controller 404 to provide the augmented reality content to and receive inputs from one or more users. In some example aspects, the controller 404 may be a standalone controller or integrated within the HMD 410. The computing device 408 may be a standalone host computer device, an on-board computer device integrated with the HMD 410, a mobile device, or any other hardware platform capable of providing artificial reality content to and receiving inputs from users. In some exemplary aspects, the HMD 410 may include an artificial reality system/virtual reality system.

The audio device (e.g., audio device 406) may receive one or more requests to provide information about an object(s) of interest from a user. The rear camera (e.g., rear camera 418) may track the eyes of a user to determine a gaze of the user at the time the request to provide information is made. In response to receipt of such a request(s) from the device, the gaze analysis component 407 may determine one or more objects of interest based on content (e.g., AR/VR/MR content) viewed in an environment via display 414. In some example aspects, the gaze analysis component may (e.g., automatically) capture one or more images and/or videos of a real world environment in response to detection of a gaze of an eye of a user for a predetermined threshold (e.g., 1 second, 2 seconds, etc.) by the user wearing the HMD 410. In other examples, the gaze analysis component 407 may capture one or more images and/or videos of the real world environment in response to receipt/detection of a voice prompt (e.g., a spoken command by a user), or other input detection (e.g., selection of a button, icon, or the like, performance of a gesture (e.g., a long pinch of a finger, etc.)). The environment may be a real world environment. The gaze analysis component 407 may generate a bounding region around the object(s) of interest and may generate an image of the content inside/within the bounding region. Applying a bounding region may enable the gaze analysis component 407 to crop an image(s) to exclude objects that may be of no interest to a user.

Bounding regions may be presented as one of many shapes (e.g., the bounding region may be a square, rectangle or other shape(s)). The gaze analysis component 407 may provide information about the content inside the bounding region based on one or more requests to provide information, or automatic detections/captures of content based on gaze detection, about the object(s) of interest. In some examples, the gaze analysis component 407 may implement a machine learning model (e.g., machine learning model(s) 910 of FIG. 9) and/or an AI model that may be pre-trained, trained in real-time, and/or periodically trained with training data (e.g., training data 930 of FIG. 9) to identify the object(s) of interest based in part on receipt of the request(s) from a device, or the gaze determination (e.g., a gaze exceeding a predetermined threshold). In some examples, the gaze analysis component 407 may further generate a segmentation mask around the object(s) of interest in the bounding region. In some examples, the gaze analysis component 407 may provide information about the content inside/within the segmentation mask. Applying a segmentation mask may allow for more precise information being provided about the object of interest based on the request to provide information, or based on, the gaze determination.

In some examples, the gaze analysis component (e.g., gaze analysis component 407) may further include, or be associated with, a MMAI model configured to receive voice input, text input, images and/or videos and may provide information pertaining to the input information (e.g., the voice input, text input, images and/or videos). In some examples, an image(s) may be sent via a network (e.g., network 155) to another device (e.g., UE 100, communication device 135, communication device 140, communication device 145, communication device 150, network device 170, computing system 300, artificial reality system 400, HMD 500) including a gaze analysis component (e.g., gaze analysis component 117, gaze analysis component 313, gaze analysis component 407, or gaze analysis component 507) to facilitate analysis of the image(s). In some examples, the gaze analysis component 407 may be within, or associated with another device located remote or external to the computing system 300.

### Another Exemplary Artificial Reality System

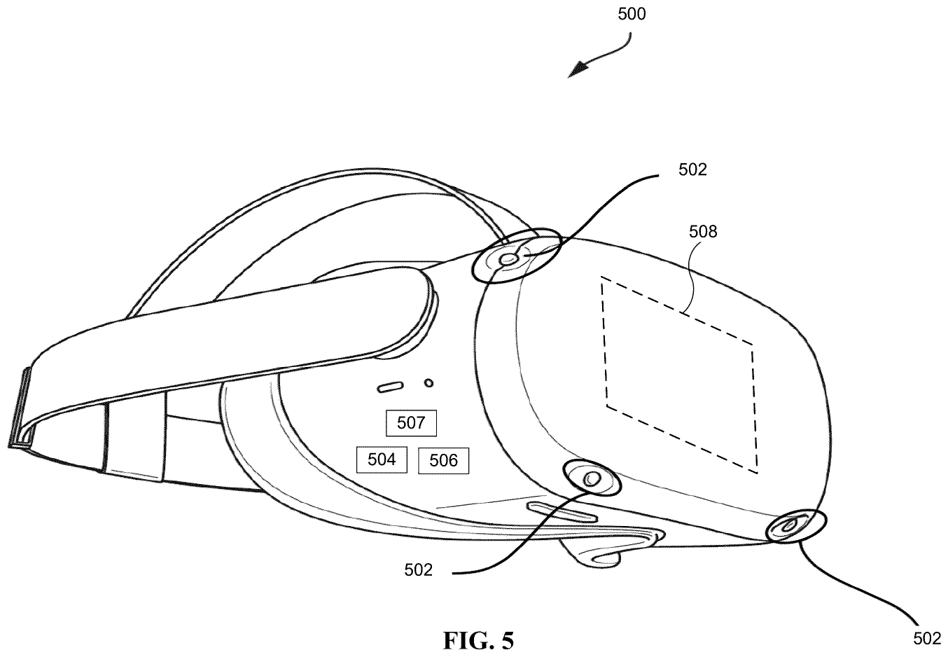

FIG. 5 illustrates another example of an artificial reality system including a HMD 500, image sensors 502 mounted to (e.g., extending from) HMD 500, according to at least one example aspect of the present disclosure. In some examples of the present disclosure, the artificial reality system 400 and/or HMD 410 may be an example of HMD 500. In some example aspects, image sensors 502 may be mounted on and protruding from a surface (e.g., a front surface, a corner surface, etc.) of HMD 500. In some exemplary aspects, HMD 500 may include an artificial reality system/virtual reality system. In an exemplary aspect, image sensors 502 may include, but are not limited to, one or more sensors (e.g., cameras 416, 418, a display 414, an audio device 406, etc.), a memory 506 (e.g., RAM, ROM) and a processor 504 (e.g., a controller (e.g., also referred to herein as controller 504)). The HMD 500 may also include a gaze analysis component 507. The gaze analysis component 507 may function and operate in a manner analogous/similar to that of the gaze analysis component 407 of FIG. 4. In exemplary embodiments, a compressible shock absorbing device may be mounted on image sensors 502. The shock absorbing device may be configured to substantially maintain the structural integrity of image sensors 502 in case an impact force is imparted on image sensors 502. In some exemplary aspects, image sensors 502 may protrude from a surface (e.g., the front surface) of HMD 500 so as to increase a field of view of image sensors 502. In some examples, image sensors 502 may be pivotally and/or translationally mounted to HMD 500 to pivot image sensors 502 at a range of angles and/or to allow for translation in multiple directions, in response to an impact. For example, image sensors 402 may protrude from the front surface of HMD 500 so as to give image sensors 502 at least a 180-degree field of view of objects (e.g., a hand, a user, a surrounding real-world environment, etc.).

The HMD 500 may further include a display 508 designed to present visual information based on an artificial reality system application(s) (e.g., VR) and/or AR application(s) as well as mixed reality application(s). Additionally or alternatively, the display 508 may be coupled (e.g., electrically coupled) to each of the image sensors 502, and may present visual information in the form of an external environment, as captured by one or more of the image sensors 502. Using one or more of the image sensors 502, the HMD 500 may capture content and/or media in the environment and may present the content/media onto the display 508. In some other examples, other content may be presented/displayed by the display 508, such as for example to an eye(s) of a user wearing the HMD 500. Some examples of such content that may be displayed by the display 508 may include, but is not limited to, text, images, videos, icons, animations, avatars and/or other graphical content.

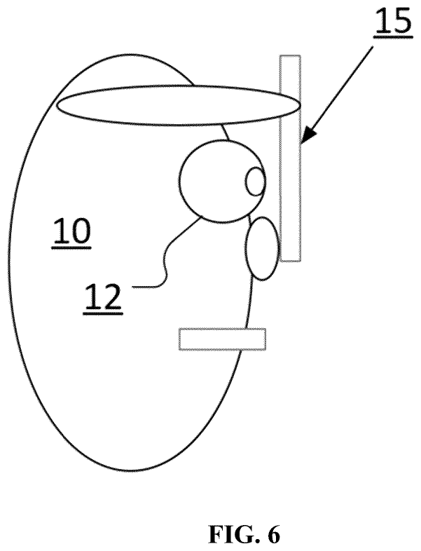

FIG. 6 is an illustrative side view of a user using an AR device, according to an example of the present disclosure. The user 10 may utilize an AR device 15 (e.g., artificial reality system 400, HMD 410, HMD 500, UE 100). In some example aspects, one more cameras (e.g., camera 124, rear camera(s) 418) may provide the eye tracking, and gaze tracking of an eye(s) (e.g., eye 12) of a user(s) (e.g., user 10). By analyzing where a user's gaze is focused within a virtual environment(s) and/or a real-world environment(s), applications may gain insights into a user's interests relating to objects of interest captured in a field of view of the environment. For example, in an instance in which a user directs their attention towards a specific object within the virtual environment and/or real-world environment, such as for example a robot standing on a desk with a laptop computer, a screen, and a microphone, the AR device may identify an object(s) of interest (e.g., the robot), and may isolate the object(s) of interest to generate an image(s) of the object(s) of interest. In some examples, the AR device 15 may identify/determine the object of interest(s) based on determining that an eye(s) (e.g., eye 12) of the user (e.g., user 10) gazes at the object(s) for a predetermined threshold (e.g., a predetermined time period (e.g., 1 second, 2 seconds, etc.)). In some other examples, the AR device 15 may identify/determine the object of interest(s) based on receipt/detection of input by a user inquiring about the object of interest(s). For purposes of illustration, and not of limitation, for example, in an instance in which a user (e.g., user 10) wears the AR device 15 and gazes at an object speaking “What am I looking at?” the AR device may capture an image of the object of interest(s) for analysis.

In some examples, an image of the object of interest (e.g., the robot) may be generated by cropping (e.g., forming a bounding region around the object of interest, with the bounding region including less content of the environment than the content captured in the field of view of the AR device), and the AR device may generate an image of the content of the bounding region. In some examples, an image of the object of interest (e.g., the robot) may be generated by performing a segmenting technique. In some examples, the segmenting may form a bounding region around the object(s) of interest, with the bounding region including less content of an environment captured in the field of view of a user, and may apply a segmentation mask to the object(s) of interest within the bounding region which may include only the object(s) of interest, and may generate an image of content of the object(s) of interest associated with the segmentation mask. Applying a segmentation mask may allow for more precise information being provided about the object(s) of interest based on a request to provide information (e.g., a request by a user to provided information) or based on a detection of a gaze of an eye(s) (e.g., eye 12) of the user satisfying (e.g., equaling or exceeding) a predetermined threshold. The generated image (e.g., the image generated based on the cropping or segmentation) may be analyzed by a gaze analysis component (e.g., gaze analysis component 117, gaze analysis component 313, gaze analysis component 407, gaze analysis component 507) to enable the gaze analysis component to provide information about the contents of the image.

The process may operate based in part on camera capture. The eye tracking system may utilize cameras (e.g., camera 124, rear camera 418) to continuously monitor the gaze of a user (e.g., user 10). In an example, the gaze analysis component may recognize that a user (e.g., user 10) is requesting a capture of an object(s) (e.g., the user may request information about an object(s) of interest captured in a field of view of a device (e.g., a camera)). In some other examples, the gaze analysis component may (e.g., automatically) capture an object(s) based on a determination of a gaze of an eye(s) (e.g., eye 12) of the user (e.g., user 10) satisfying a predetermined threshold. The AR device may isolate the object(s) of interest to generate the image of the object. In some examples, isolation of the object(s) of interest to generate the image of the object may entail applying a segmentation mask and cropping the object(s) of interest to generate/obtain the image that may include only the object of interest over a background that may be chosen/selected to be distinct from the object of interest and may be neutral. For example, the background may be a white background, or a black background, or any other background in which only the image of the object may be in the foreground.

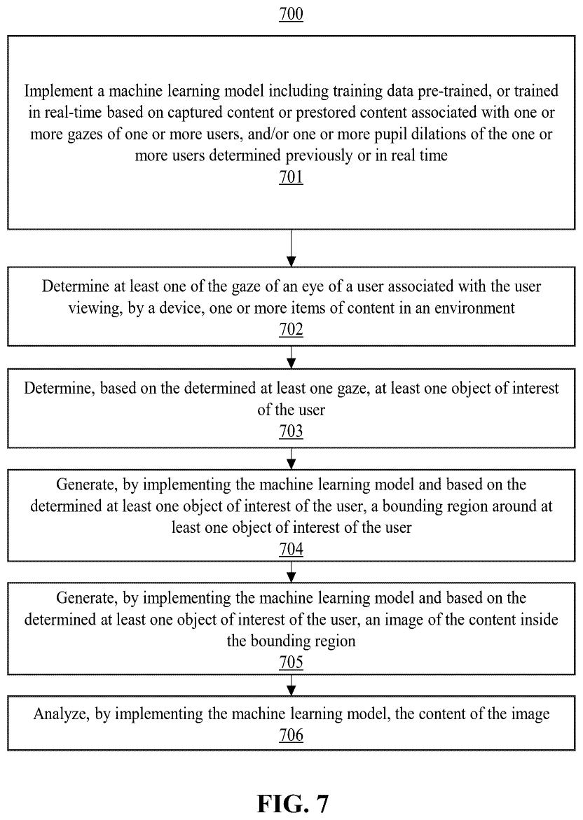

FIG. 7 is a flow diagram of an example flowchart illustrating operations for isolating an object within an AR environment by cropping, according to an example of the present disclosure. At operation 701 of the method 700, a device (e.g., AR device 15) may implement a machine learning model (e.g., machine learning model(s) 910) including training data (e.g., training data 930) pre-trained, or trained in real-time based on captured content or prestored content associated with one or more gazes of one or more users, and/or one or more pupil dilations of the one or more users determined previously or in real time.

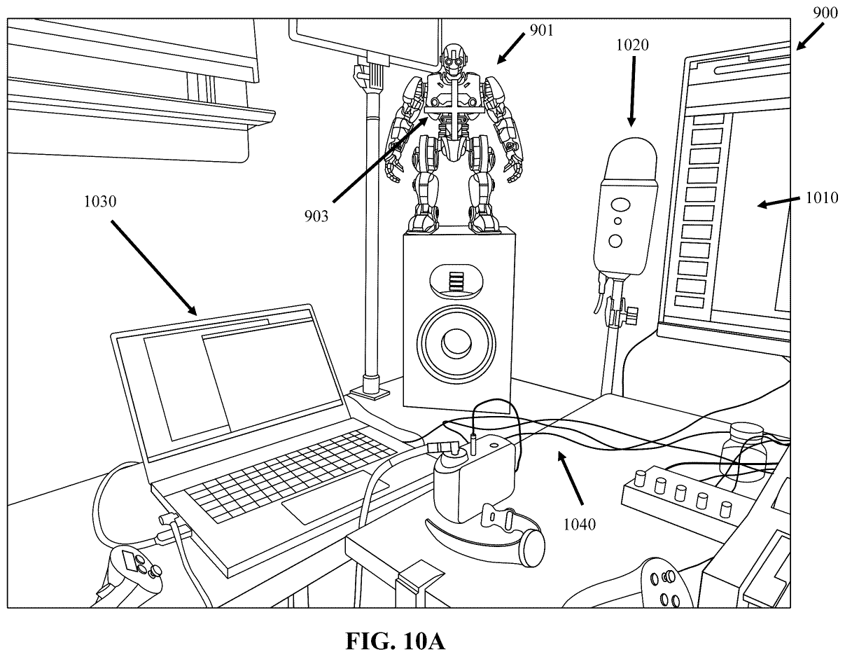

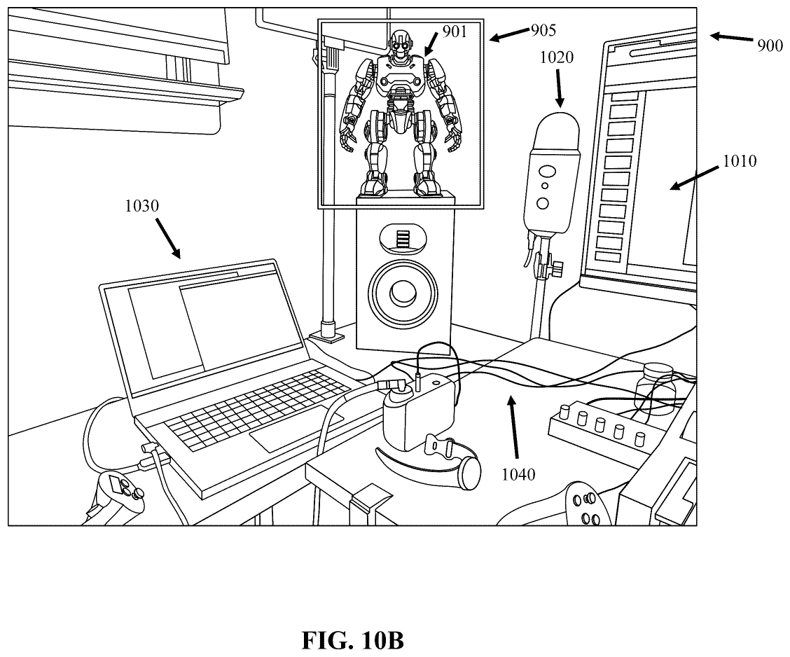

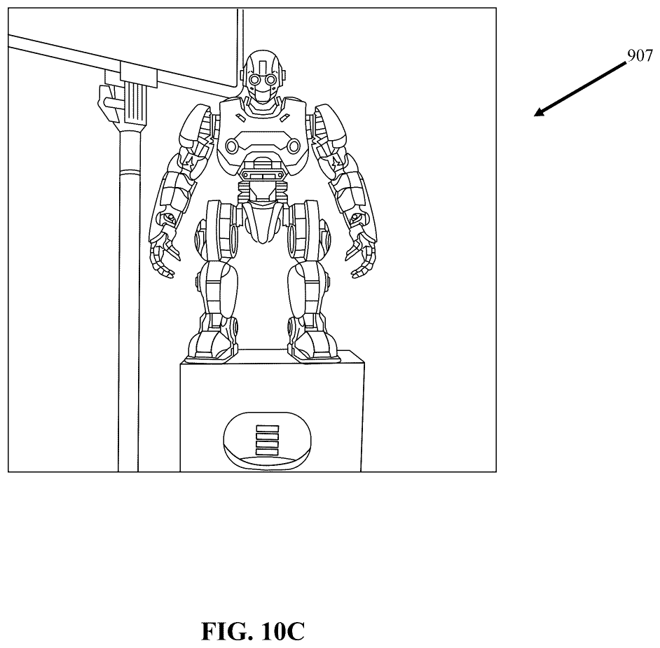

At operation 702, a device (e.g., AR device 15) may determine at least one of the gaze of an eye (e.g., eye 12) of a user (e.g., user 10) associated with the user viewing, by the device, one or more items of content in an environment. The environment may be a real world environment. At operation 703, a device (e.g., AR device 15) may determine, based on the determined at least one gaze (e.g., indicated by reticle 903 in FIG. 10A), at least one object(s) of interest (e.g., robot 901 in FIG. 10A) of the user. At operation 704, a device (e.g., AR device 15) may generate, by implementing the machine learning model and based on the determined at least one object(s) of interest of the user, a bounding region(s) (e.g., bounding box 905 in FIG. 10B) around at least one object(s) of interest (e.g., robot 901) of the user. The bounding region(s) may be presented as one of many shapes (e.g., the bounding region may be a square, rectangle or any other suitable shape(s)). In some examples, the device (e.g., AR device 15) may be prompted to capture the gaze of the user (e.g., the user speaks and an audio device (e.g., audio device 406) captures audio indicating interest in learning information about the object(s) of interest). In some other examples, the user may prompt the device to capture the user's gaze based on voice, text, or other input(s). Additionally, in some other examples, the object(s) of interest may be determined (e.g., automatically) by the AR device in response to determination of a gaze of an eye(s) of the user at an object(s) (e.g., in a view of a real world environment) for a predetermined threshold.

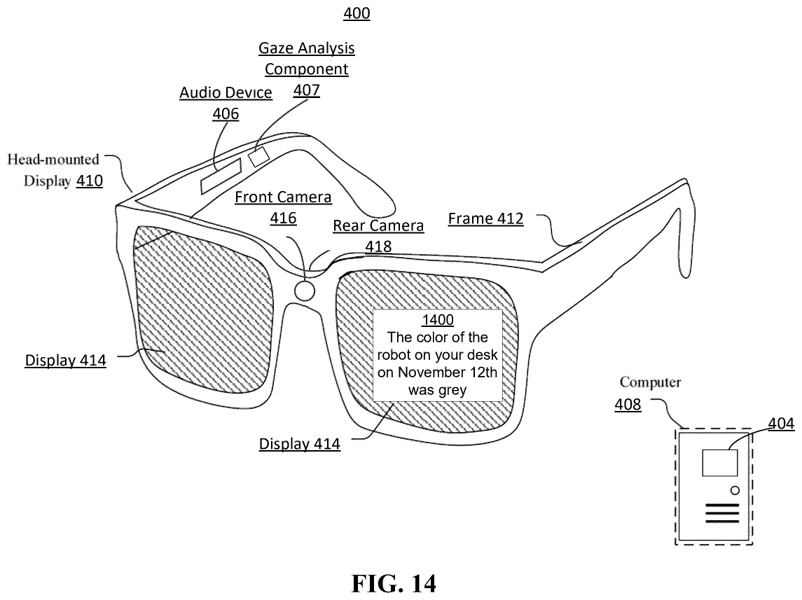

At operation 705, a device (e.g., AR device 15) may generate, by implementing the machine learning model and based on the determined at least one object(s) of interest of the user, an image of the content (e.g., image 907 of FIG. 10C) inside/within the bounding region (e.g., a bounding box (e.g., bounding box 905)). The image of the content may be content associated with the environment captured in the field of view (e.g., a camera (e.g., camera 124, rear camera 418)) of the device. The image (e.g., image 907) may be generated using a bounding region or by cropping the image, such as an image associated with robot 901, (e.g., at a center of the image) associated with a determined gaze position. At operation 706, a device (e.g., AR device 15) may analyze, by implementing the machine learning model, the content associated with the image (e.g., the cropped image). In some examples, the device may send the image to another device (UE 100, computing system 300), network device 170, etc.), application and/or model (e.g., machine learning model(s) 910) to facilitate analysis of the image. The other device that receives the image (e.g., the cropped image) may include a gaze analysis component (e.g., gaze analysis component 117, gaze analysis component 313, or gaze analysis component 407). The model (e.g., machine learning model(s) 910) that may receive the image (e.g., image 907) may perform functions analogous to a gaze analysis component, and/or may implement a gaze analysis component. Analyzing the image (e.g., the cropped image) may enable a device (e.g., a gaze analysis component) and/or the model to answer questions about the image of the object(s) of interest. In some examples, the device (e.g., gaze analysis component) and/or the model (e.g., machine learning model(s) 910) may store determinations and/or answers about the information, in a memory device, regarding the object(s) of interest. In this regard, in instance in which the device and/or model may need to determine information (e.g., in response to a future query) about the object(s) of interest, the device and/or model may retrieve the information from the memory device and may present the information to a user or a device upon receipt of a request. For purposes of illustration, and not of limitation, for example, in an instance in which a user may utilize their voice to ask a query such as “What color was the robot on my desk on November 12th,” a prior date, in this example, the device and/or the model may capture the query and retrieve the information about this object(s) of interest (e.g., the robot) and may present the answer to the query to the user. In this example, the answer may be “The color of the robot on your desk on November 12th was grey.” In some examples, the device and/or the model may present the answer to this query to the user as an audio output (e.g., e.g., a synthesized voice (e.g., a computer generated voice)). In other examples, the device and/or the model may provide this answer to the query as text displayable by a display device (e.g., display 414, display 508). For example, FIG. 14 illustrates that text 1400 indicating may be displayed by display 414 to a user. In some examples, the text 1400 may be inverted and may appear at a position/direction of an eye(s) of a user such that the text 1400 is legible to the user while wearing the HMD 410.

In some examples, the gaze analysis component may determine information about the image (e.g., the cropped image) which is of interest to the user. For purposes of illustration and not of limitation, for example, a gaze analysis component may generate one or more sentences or paragraphs of information about the image that is of interest to the user in response to a user query inquiring about an object(s) of interest associated with the image. The device (e.g., the gaze analysis component) and/or the model (e.g., machine learning model(s) 910) may determine a cropped image of the object(s) of interest, which may enable the device and/or the model to provide more precise results about the user's question(s) (e.g., a question such as “What is this?”) about the image of interest to the user. For example, since the cropped image may include the image of the object(s) of interest, with content items of no interest to the user excluded, the device (e.g., gaze analysis component) and/or the model may more precisely answer questions from the user about the image (e.g., the cropped image) than instances in which the content items may have been included with the image. For example, by removing the background content items from the image of the object(s) of interest, the device and/or the model may be better able to more accurately determine a description about the object(s) of interest.

In some examples, in an instance in which a user asks a query (“What is this that I'm looking at?”) about an object of interest, the device and/or the model may capture and analyze a predetermined threshold (e.g., the last N number) of seconds (or milliseconds) to determine an average of gaze vectors associated with gazes of an eye(s) of the user to determine a location/position of an object(s) of interest that the user is viewing (e.g., based on the average of the gaze vectors). This technique may take into account that a user's eyes may flicker constantly in some instances, which may make a single gaze determination inaccurate to determine the object(s) of interest to the user.

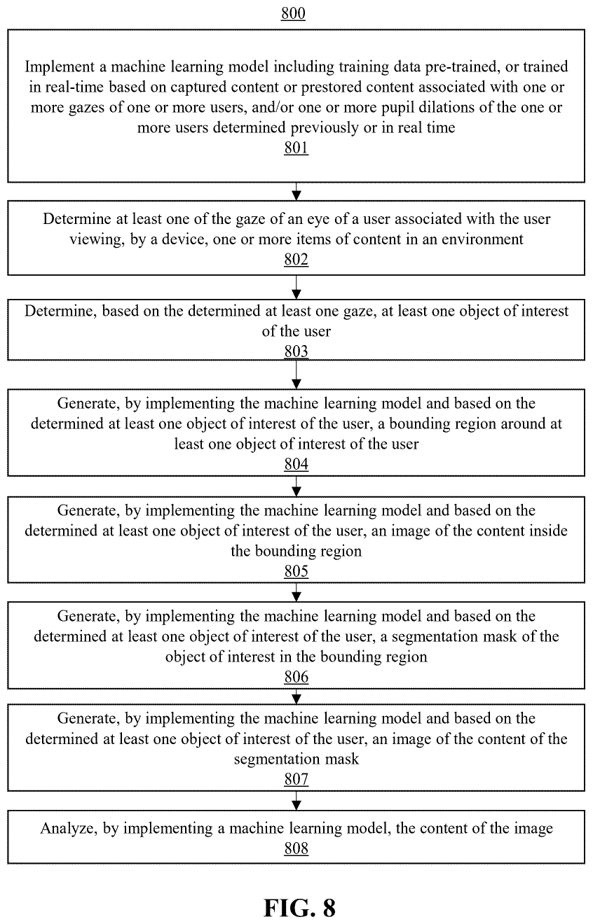

FIG. 8 is a flow diagram of an example flowchart illustrating operations for isolating an object within an AR environment by segmentation according to an example of the present disclosure. At operation 801 of method 800, a device (e.g., AR device 15) may implement a machine learning model (e.g., machine learning model(s) 910) including training data (e.g., training data 930) pre-trained, or trained in real-time based on captured content or prestored content associated with one or more gazes of one or more users, and/or one or more pupil dilations of the one or more users determined previously or in real-time.

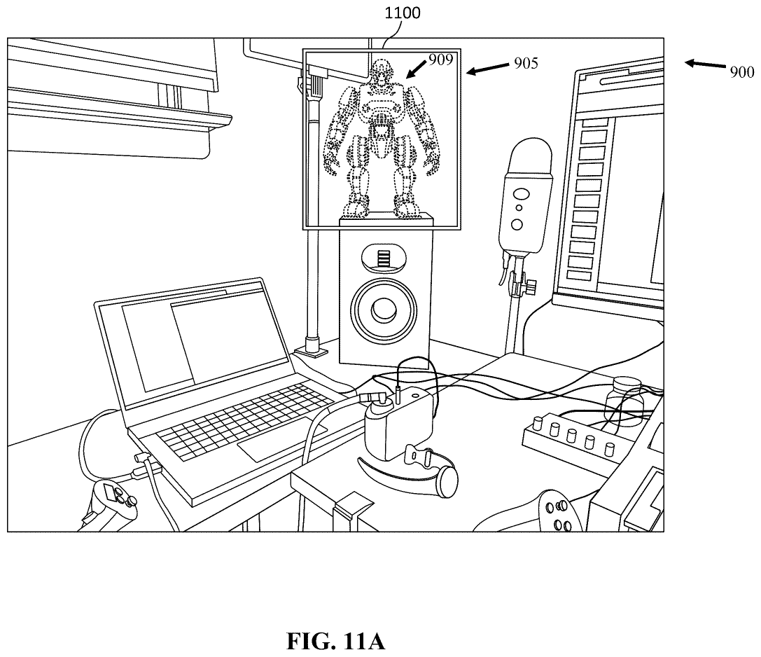

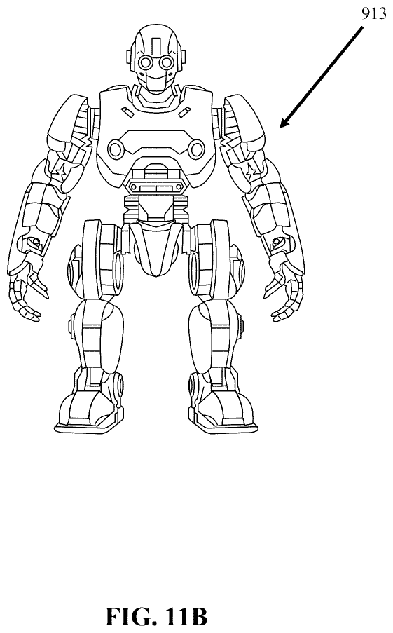

At operation 802, a device (e.g., AR device 15) may determine at least one of the gaze (e.g., as indicated by reticle 903 in FIG. 10A) of an eye(s) (e.g., eye 12) of a user (e.g., user 10) associated with the user viewing, by the device, one or more items/objects of content in an environment. The environment may be a real-world environment. The device may be prompted to capture the gaze of a user (e.g., the user may speak indicating interest in learning information about an object of interest). The user may prompt the device to capture the user's gaze based voice input, text input, or other input(s), or based on a gesture (e.g., a long pinch with at least two fingers, a virtual right click with a finger, etc.). In some other examples, a gaze that may be determined automatically based on satisfying a predetermined threshold may trigger the device to capture an image of the object of interest associated with the gaze. At operation 803, a device (e.g., AR device 15) may determine, based on the determined at least one gaze, at least one object of interest (e.g., robot 901) of the user. At operation 804, a device (e.g., AR device 15) may generate, by implementing the machine learning model and based on the determined at least one object of interest of the user, a bounding region (e.g., bounding box 1105 of FIG. 11A) around at least one object of interest (e.g., robot 901) of the user.

Bounding regions may be presented as one of many shapes (e.g., the bounding region may be a square, a rectangle, or other shape(s)). At operation 805, a device (e.g., AR device 15) may generate, by implementing the machine learning model and based on the determined at least one object of interest of the user, an image associated with the content inside/within the bounding region. The content may be associated with content items captured in a field of view (e.g., a field of view of a camera) of the device in a real world environment. At operation 806, a device (e.g., AR device 15) may generate, by implementing the machine learning model and based on the determined at least one object of interest of the user, a segmentation mask of the object of interest in the bounding region (e.g., mask 1109 of FIG. 11A). At operation 807, a device (e.g., AR device 15) may generate, by implementing the machine learning model and based on the determined at least one object of interest of the user, an image (e.g., image 913 of FIG. 11B) of the content of the segmentation mask.

At operation 808, a device (e.g., AR device 15) may analyze, by implementing a machine learning model, the content of the image (e.g., image 913), which may be an image of an object of interest to the user (e.g., user 10). Analysis of the image may enable the device to provide information (e.g., information 921) to a user about the image of interest to the user. Analysis of an image generated by segmentation may enable more precise information to be provided about the object of interest. For instance, the segmentation mask 909 used to segment an image of the object of interest (e.g., robot 901) may remove superfluous background content items from an image 1100 which may enable the device (e.g., AR device 15) to generate a more accurate and focused description of the image 913 associated with the object(s) of interest. In some examples, the gaze analysis component may provide specific information about the object of interest (e.g., the gaze analysis component may generate one or more responses to a question(s) by the user about the object). In some other examples, in instances in which the device (e.g., AR device) determines the object(s) of interest based on a gaze satisfying a predetermined threshold, the device and/or a model may save/store the specific determined information about the object(s) of interest in a memory device which may be accessed to facilitate subsequent queries about the object(s) of interest.

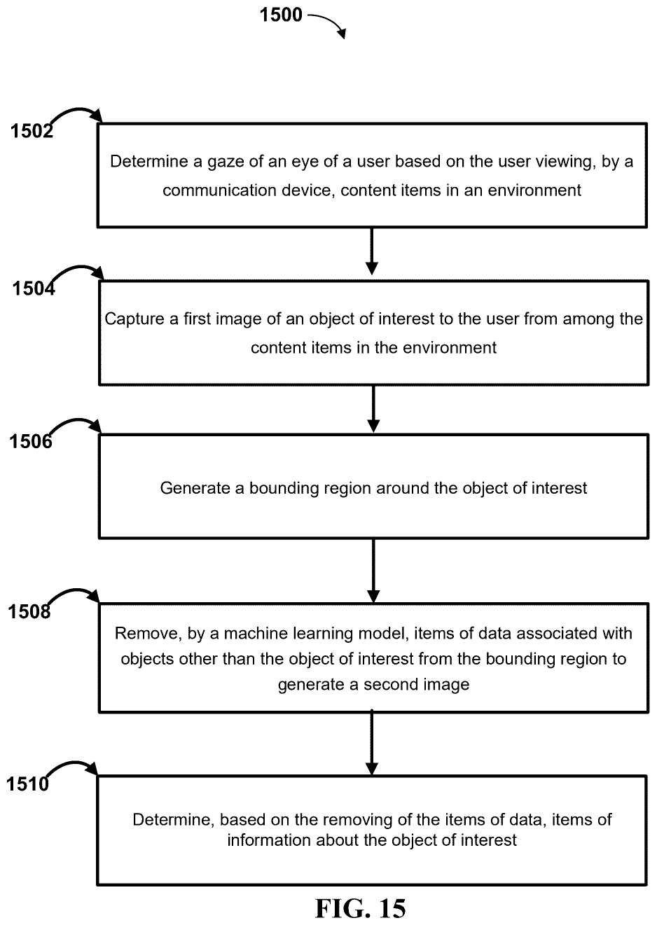

FIG. 9 illustrates an example of a machine learning framework 902 including machine learning model(s) 910 and a training database 920, in accordance with one or more examples of the present disclosure. The training database 920 may store training data 930. In some examples, the machine learning framework 902 may be hosted locally in a computing device or hosted remotely. By utilizing the training data 930 of the training database 920, the machine learning framework 902 may train the machine learning model(s) 910 to perform one or more functions, described herein, of the machine learning model(s) 910. In some examples, the machine learning model(s) 910 may be stored in a computing device. For example, the machine learning model(s) 910 may be embodied within a communication device (e.g., UE 100). In some other examples, the machine learning model(s) 910 may be embodied within another device (e.g., computing system 300, artificial reality system 400, AR device 15, HMD 500). Additionally, the machine learning model(s) 910 may be processed by one or more processors (e.g., processor 102 of FIG. 2, coprocessor 302 of FIG. 3, controller 404 of FIG. 4, controller 504 of FIG. 5). In some examples, the machine learning model(s) 910 may be associated with operations (or performing operations) of FIG. 7, FIG. 8, and FIG. 15. In some other examples, the machine learning model(s) 910 may be associated with other operations. In some examples, the machine learning model(s) 910 may be an example of the gaze analysis component 117, gaze analysis component 313, the gaze analysis component 407, and/or the gaze analysis component 507.

The training data 930 employed by the machine learning model(s) 910 may be pre-trained, fixed or updated periodically. Alternatively, the training data 930 may be updated in real-time based upon the evaluations performed by the machine learning model(s) 910 in a non-training mode. This may be illustrated by the double-sided arrow connecting the machine learning model(s) 910 and stored training data 930 which may be stored in the training database 920. Some other examples of the training data 930 may include, but are not limited to, items of content determined as being associated with a network (e.g., network 155) (e.g., the Internet, a social network, etc.), a platform (e.g., system 130), or the like.

For purposes of illustration and not of limitation, for example, the training data 930 may relate to attributes of objects. For example, the object(s) may be one or more gazes of an eye(s) of one or more users, and/or pupil dilations of one or more eyes of a user. Attributes may include, but are not limited to, one or more time periods, orientations, a gaze(s). In some example aspects, a gaze(s) may be an input parameter(s) of a segmentation model(s) and may not need to be utilized in the training of the segmentation model. The segmentation model may be a portion or a subset of the machine learning model(s) 910 or another machine learning model(s) 910. The gaze(s) may be utilized to determine a point(s) on an image (e.g., that a user may be looking at/viewing) and the point(s) may be utilized to determine the segment of the image the user is gazing at. The determined segment may be provided/fed to an MMAI large language model (LLM) (e.g., a same machine learning model(s) 910 or another machine learning model(s) 910). In some other example aspects, the training data 930 may be utilized to train the machine learning model(s) 910 to determine a gaze(s) of a user of a device. Additionally, as described above, the machine learning model(s) 910 may be trained at an initial stage, in real-time and/or trained periodically (e.g., updated periodically). The machine learning model(s) 910 may be capable of combining similar groupings (e.g., groupings of cats, grouping of dogs, groupings of other similar entities/objects) and/or distinguishing between groupings of similar objects to isolate an object(s) of focus. The groupings and/or separation may be accomplished via segmentation models using a gaze position(s) and/or the semantic information of the segments detected in an image(s). Fine tuning of the segmentation model may be accomplished by providing a gaze position(s) as an input, either by including the gaze position(s) in the image(s), and/or providing the gaze position(s) as a separate parameter(s). Similarly, the training of the MMAI model may be fine tuned in a similar manner.

In some examples, the machine learning model(s) 910 may evaluate attributes of a user(s) by hardware (e.g., of the AR device 15, UE 100, computing system 300, artificial reality system 400, HMD 500, etc.). For example, one or more cameras (e.g., camera 124, rear camera 418) may sense and/or capture a gaze angle of an eye(s) of a user(s), a pupil dilation of an eye(s) of a user(s), which may be associated with the content being displayed to a user(s) (e.g., in a field of view of a camera (e.g., camera 124, rear camera 418)). The attributes of a captured gaze(s), a determined pupil dilation(s) of a user(s) may then be compared with respective attributes of stored training data 930 (e.g., prestored training gazes, prestored pupil dilations, and/or the like). The likelihood of similarity between each of the obtained attributes (e.g., of the captured gaze(s), and/or the pupil dilation(s) and the stored training data 930 (e.g., prestored training gazes, and pupil dilations) may be analyzed to a determine a confidence score(s). In some example aspects, in an instance in which the confidence score(s) equals or exceeds a predetermined threshold, the attribute(s) may be utilized by the machine learning model(s) 910 to generate or determine the gaze(s) of a user(s) and/or a pupil dilation(s) of a user(s). For example, in an instance in which a gaze vector of a detected gaze of a user is within a predetermined/predefined threshold of a gaze vector of the prestored gazes of the training data 930, the machine learning model(s) 910 may determine that the detected gaze of the user is accurate, or valid.

Referring now to FIG. 10A, a diagram illustrating an environment 900 that may be viewed using a device (e.g., AR device 15) is provided in accordance with exemplary aspects of the present disclosure. The environment 900 may have objects that may be captured in a field of view of the device which may be displayed (e.g., via display/touchpad/user interface(s) 112, display 307, display 414, display 508) to the user. In the example of FIG. 10A the objects may be include, but are not limited to the robot 901, screen 1010, microphone 1020, laptop 1030, wires 1040, and other content items in the environment 900 as shown in FIG. 10A). In some examples, the environment may be a real-world environment viewed via the device, with visual artificial reality content displayed to a user (e.g., user 10) by the device. In some other examples, the environment (e.g., environment 900) may be a virtual environment displayed to the user. In other examples, the environment (e.g., environment 900) may be a mix of a real world and virtual world environment. A device (e.g., AR device 15) may determine the gaze(s) of an eye(s) of a user. The determined gazes(s) may be the direction in which the eye(s) of a user(s) may be focused/looking and/or the movement/motion of the eye(s) shifting focus from one point to another point. The device may be prompted to capture/determine the gaze of an eye(s) of the user (e.g., the user may speak indicating interest in learning information about an object of interest captured in the field of view of the device). A sensor device (e.g., speaker/microphone 108, audio device 406, image sensors 502) may capture the user's voice data associated with the speech content indicating the interest in learning the information about the object of interest. In some other examples, the user may prompt the device to capture the user's eye(s) gaze based on a detected voice input, text input, and/or other input(s). For purposes of illustration and not of limitation, the user may speak (or type as text input) to the device “What type of object is this that I am looking at?” The gaze analysis component (e.g., gaze analysis component 117, gaze analysis component 313, gaze analysis component 407, or gaze analysis component 507) of the device may receive input from the eye tracking system (e.g., rear camera(s) 418) of the device to determine the gaze of an eye(s) of the user. The motion and/or direction in which the eyes of the user(s) may be focused as the determined gaze of the user may cause the gaze analysis component of the device to project/present a reticle 903 onto an object of interest in the field of view of the camera being looked at/viewed by the user. For instance, based on the determined gaze of the eye(s) of the user, and the reticle 903 (e.g., superimposed on an object(s)), the device may determine an object(s) of interest (e.g., a robot 901) captured in the field of view of the device in the environment 900. In some examples, the reticle 903 may be a red, green, blue (RGB) presentation of the reticle 903 within the field of view of a camera (e.g., camera 124, front camera(s) 416, image sensor(s) 502), based on one or more known parameters.

Referring now to FIG. 10B, a diagram illustrating an environment 900 that may be viewed by a device (e.g., AR device 15) is provided in accordance with exemplary aspects of the present disclosure. Based on the determined reticle 903 of FIG. 10A, which may be superimposed on the object(s) of interest (e.g., robot 901) of the user based on the determined gaze of the user, the gaze analysis component may generate/create a bounding region such as, for example bounding box 905 around the object(s) of interest of the user such as, for example robot 901. The bounding region may be any shape(s) (e.g., a square, rectangle, other shape(s)) that may include the object(s) of interest.

Referring now to FIG. 10C, a diagram illustrating a cropped image associated with an environment using a device is provided in accordance with exemplary aspects of the present disclosure. The environment may be the environment 900 (also shown in FIG. 10A and FIG. 10B). The device, by implementing a gaze analysis component (e.g., gaze analysis component 117, gaze analysis component 313, gaze analysis component 407, or gaze analysis component 507) may crop an image such as, for example, image 907 based on one or more content items captured inside/within the bounding region (e.g., bounding box 905). As described above, the bounding region may be determined and associated with the determined reticle 903 which may be generated based on the determined gaze of an eye(s) (e.g., eye 12) of the user (e.g., user 10). In some examples, a MMAI model (e.g., machine learning model(s) 910) of the gaze analysis component may analyze the cropped image 907 associated with the object(s) of interest (e.g., robot 901) of the user to store determined information about the object of interest and/or to provide information to the user (e.g., user 10) about the object(s) of interest. For instance, the user may provide input to the device regarding a question(s) (e.g., when looking at the object(s) of interest) such as, for example, “What type of object is this?” By removing several content items (e.g., the laptop 1030, the screen 1010, the microphone 1020, the wires 1040, and/or other content items) from the content of the environment 900 that may be of no interest to the user, the MMAI model (e.g., machine learning model(s) 910) of, or associated with, the gaze analysis component may more accurately and precisely answer the question of the user about the object(s) of interest. In this regard, in some examples, the latency may be reduced/minimized in answering the question (by the MMAI model of the gaze analysis component) about the object(s) of interest, which may conserve processing capacity of processing components (e.g., processor 102, controller 404, controller 504) of the device.

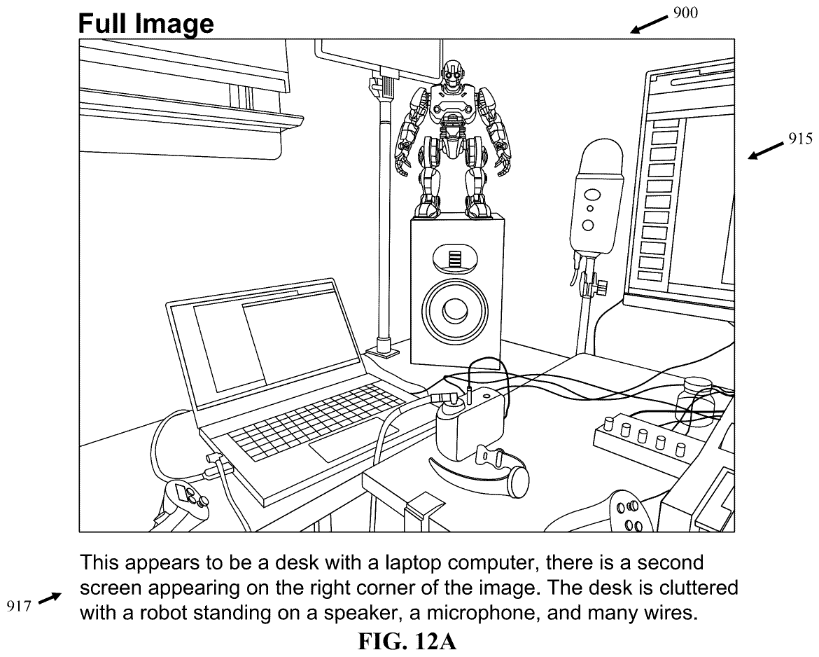

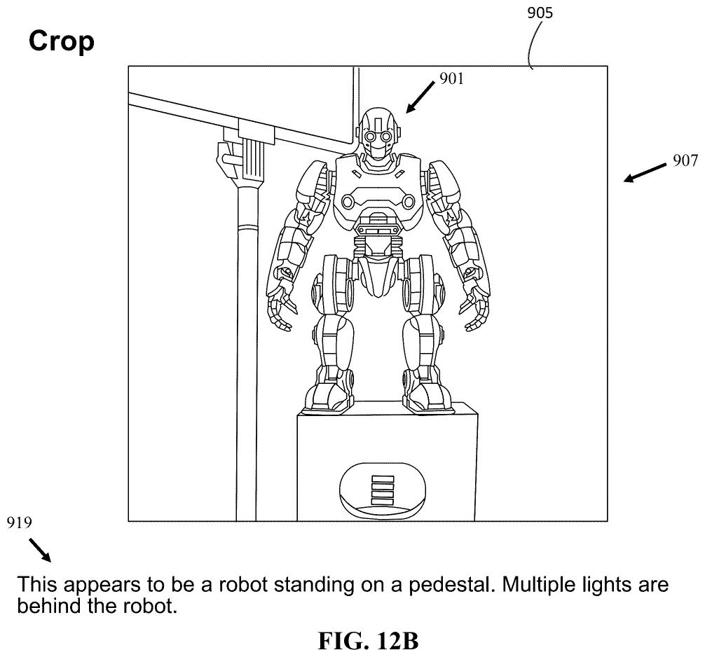

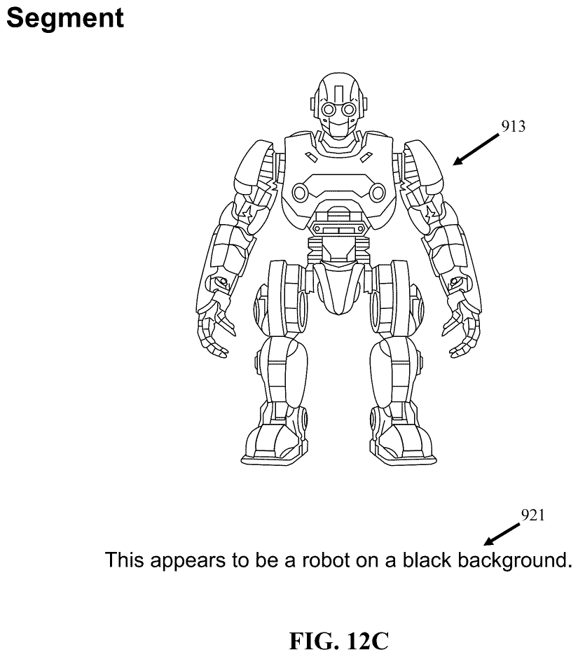

In some other examples, the generated image such as cropped image 907 may be sent via a network (e.g., network 155) to another device (e.g., UE 100, communication device 135, communication device 140, communication device 145, communication device 150, network device 170, computing system 300, or artificial reality system 400 or HMD 500) that includes a gaze analysis component (e.g., gaze analysis component 117, gaze analysis component 313, gaze analysis component 407, or gaze analysis component 507) for the other device to analyze the cropped image 907. Analysis by a gaze analysis component may enable the device to provide information (e.g., information 919 (also referred to herein as description 919) in FIG. 12B), in response to a question by a user, such as e.g., “What is this?”) about the object(s) of interest (e.g., robot 901) to a user (e.g., user 10). In this regard, the gaze analysis component may generate specific information (e.g., one or more sentences and/or one or more paragraphs of information (e.g., in response to a user question(s)) about the object(s) of interest. In some other examples, in response to determining a gaze of a user satisfies a predetermined threshold, the gaze analysis component may capture an image of the object of interest, may segment the image or crop the image by removing superfluous content from the image and may determine information about the object of interest captured in the image.

For the purpose of illustration and not of limitation, as an example, a user (e.g., user 10) may view environment 900 using AR device 15. While looking at robot 901, user 10 may ask, “What is it?” The question may cause AR device 15 to determine that user 10 is requesting an image/photo capture of the robot 901 being looked at/viewed. In response to the user 10 looking at the robot 901, the AR device 15 may determine a gaze(s) of an eye(s) of the user. In response to determining the gaze of the eye(s) of the user, the AR device 15 may capture an image/photo of the robot (e.g., robot 901). The AR device 15 may implement a gaze analysis component (e.g., gaze analysis component 117, gaze analysis component 313, gaze analysis component 407, gaze analysis component 507) to determine that a gaze of an eye(s) (e.g., eye 12) of the user is directed at the robot 901. The AR device 15 may then implement the gaze analysis component to generate a bounding region (e.g., bounding box 905) around robot 901. The AR device 15 may then implement the gaze analysis component to generate a cropped image 907 of the content within the bounding box 905.

Referring now to FIG. 11A, a diagram illustrating an environment that may be viewed using a device is provided in accordance with exemplary aspects of the present disclosure. The environment 900 may have objects displayed to the user such as, for example, robot 901, a screen (e.g., screen 1010), a microphone (e.g., microphone 1020), a laptop (e.g., laptop 1030), wires (e.g., wires 1040) and/or other content items in the environment. The environment 900 may be a real-world environment viewed through/via the device. Based on the determined gaze of the user, a device (e.g., AR device 15) may determine an object of interest (e.g., a robot 901). Additionally, based on the determined gaze of the user, a gaze analysis component (e.g., gaze analysis component 117, gaze analysis component 313, gaze analysis component 407, gaze analysis component 507) of the device may generate a bounding region (e.g., bounding box 905) around the object of interest of the user (e.g., robot 901). The bounding region may be any shape(s) that may include the object of interest. In response to determining the object(s) of interest of the user, the device may implement the gaze analysis component to generate a segmentation mask (e.g., segmentation mask 909 (e.g., denoted by the dashed outline of the robot 901) of an object of interest in the bounding region (e.g., bounding box 905). The segmentation mask (e.g., segmentation mask 909) may match the pixels (e.g., exact pixels) of the object of interest (e.g., the segmentation mask may include only the object of interest by removing all other content other than the object of interest). In other words, the segmentation mask may be associated with the positions of the pixels that make up an object(s) of interest in an image(s). In this regard, in the example of FIG. 11A, the segmentation mask 909 may include the pixels that make up, or are associated with, the object of interest such as robot 901, but may exclude pixels of other content items.

Referring to FIG. 11B, a diagram illustrating a segmented image of an object of interest viewed in an environment (e.g., environment 900 from FIG. 11A) using a device is provided in accordance with exemplary aspects of the present disclosure. A device (e.g., AR device 15) may generate a segmentation mask (e.g., segmentation mask 909 of FIG. 11A) around an object of interest (e.g., robot 901) as previously described herein. The device may implement a gaze analysis component (e.g., gaze analysis component 117, gaze analysis component 313, gaze analysis component 407, or gaze analysis component 507) to generate an image (e.g., image 913 of FIG. 11B) based on the determined object of interest (e.g., robot 901) and the segmentation mask (e.g., segmentation mask 909). The segmentation mask may be applied to the image (e.g., image 1100) to remove all pixels from the image 1100 that may not correspond to the segmentation mask. In this manner, the segmentation mask may facilitate creation/generation of a new image including (e.g., only) the object of interest (e.g., robot 901). In some examples, the image may include only the object of interest over a background that may be chosen/selected, by the gaze analysis component, to be neutral and distinct from the object of interest (e.g., a colorful object of interest may be placed over a white background, a black background, etc.). The device may analyze the image using the gaze analysis component and/or a MMAI model (e.g., machine learning model(s) 910).

In some examples, a MMAI model (e.g., machine learning model(s) 910) of, or associated with, the gaze analysis component may analyze the image 913 associated with the object(s) of interest (e.g., robot 901) of the user and the segmentation mask 909 to store information about the object of interest and/or to provide information to the user (e.g., user 10) about the object(s) of interest. For example, the user may provide input to the device regarding a question(s) (e.g., when looking at the object(s) of interest) such as, for example, “What is it?” By removing several content items (e.g., the laptop 1030, the screen 1010, the microphone 1020, the wires 1040, and/or other content items) from the content of the environment 900, via the segmentation mask 909, that may be of no interest to the user, the MMAI model of, or associated with, the gaze analysis component may more accurately and precisely answer the question of the user about the object(s) of interest. In this manner, in some examples, the latency may be reduced/minimized in answering the question (by the MMAI model of the gaze analysis component) about the object(s) of interest, which may conserve processing capacity of processing components (e.g., processor 102, co-processor 302, controller 404, controller 504) of the device.

In some examples, the generated image 913 may be sent via a network (e.g., network 155) to another device (e.g., UE 100, communication device 135, communication device 140, communication device 145, communication device 150, network device 170, computing system 300, or artificial reality system 400 or HMD 500) that may include a gaze analysis component (e.g., gaze analysis component 117, gaze analysis component 313, gaze analysis component 407, or gaze analysis component 507) to analyze the image 913. Analysis by a gaze analysis component may enable the other device to provide information (e.g., information 921 (also referred to herein as description 921) in FIG. 12C, in response to a user question, “What is this?”) to a user (e.g., user 10) about the object(s) of interest. In some examples, but not all examples, information provided about an image (e.g., image 913) generated by segmentation (e.g., segmentation mask 909) may be more precise than information provided about an image generated by cropping (e.g., image 907). This may be because the image generated based on the segmentation mask may remove more superfluous information than an image generated by cropping since the segmentation mask may, but need not, include only the pixels associated with the object of interest while excluding pixels of other content items. In some examples, the gaze analysis component may generate specific information (e.g., the gaze analysis component may provide/generate one or more sentences or one or more paragraphs of information) about the object(s) of interest.

For the purpose of illustration and not of limitation, as an example, a user (e.g., user 10) may view environment 900 using AR device 15. While looking at robot 901, user 10 may ask, “What is it?” The question may cause AR device 15 to determine that user 10 is requesting an image/photo capture. In response to determining that the user is looking at the robot 901 in a field of view of the device, a gaze analysis component of the AR device 15 may determine a gaze of an eye(s) (e.g., eye 12) of a user (e.g., user 10). The AR device 15 capture an image/photo of the robot 901. The AR device 15 may implement the gaze analysis component (e.g., gaze analysis component 117, gaze analysis component 313, or gaze analysis component 407) to determine that gaze of the eye(s) of the user is directed at robot 901. The AR device 15 may then implement the gaze analysis component to generate a bounding region (e.g., bounding box 905) around robot 901. The AR device 15 may then implement the gaze analysis component generate a segmentation mask (e.g., segmentation mask 909) associated with robot 901. In response to generating the segmentation mask 909, the AR device 15 may generate an image 913 of robot 901.

Referring to FIG. 12A, a diagram illustrating an example image 915 of an environment 900 that may be viewed using a device (e.g., AR device 15) with an example description 917 of the image 915 is provided in accordance with exemplary aspects of the present disclosure. FIG. 12A illustrates an example description 917 that may be generated by an image 915 being analyzed by a MMAI model (e.g., a machine learning model(s) 910) of or associated with a gaze analysis component to facilitate analysis of the image 915. In the example presented in FIG. 12A, the image 915 may not be cropped or segmented, and may indicate the entire scene of environment 900. A description (e.g., description 917) may be generated in response to being presenting with a question (e.g., a user may have asked “What is this?”) to the MMAI model that has analyzed the image 915. In response to the question (e.g., “what is this?”), the MMAI model may generate an answer describing the image (e.g., description 917). In this manner, the gaze analysis component may provide specific information (e.g., one or more sentences and/or one or more paragraphs of information) about an image (e.g., image 915) of interest.

Referring to FIG. 12B, a diagram illustrating an image of the content of a bounding region (e.g., a bounding box) around an object of interest included in an environment that may be viewed using a device is provided in accordance with exemplary aspects of the present disclosure. A device (e.g., AR device 15) may determine a gaze of an eye(s) of the user. Based on the determined gaze of the eye(s) of the user, the device may determine an object of interest (e.g., a robot 901). Based on the determined gaze of the user, the device, by implementing a gaze analysis component (e.g., gaze analysis component 117, gaze analysis component 313, or gaze analysis component 407) may generate a bounding region (e.g., bounding box 905) around an object of interest (e.g., robot 901) of the user. The bounding region may be any shape(s) that may include the object of interest. An image such as, for example, cropped image 907 of the content inside a bounding region (e.g., bounding box 905) may be generated by a device (e.g., AR device 15) by implementing the gaze analysis component and based on the determined gaze of the eye(s) of the user (e.g., user 10). The device may analyze the image using the gaze analysis component in the manner described above to provide information about the cropped image 907. For example, in the example of FIG. 12B, an MMAI model of the gaze analysis component may determine an answer (e.g., to a user question such as “What is this?”) about the cropped image 907 such as description 919 of FIG. 12B. The description 919 may be presented with the cropped image 907 and may be viewable by the user in the field of view (e.g., camera 124, front camera(s) 416) of the device.

Referring to FIG. 12C, a diagram illustrating an image of the content of a segmentation mask of an object of interest included in a bounding region (e.g., bounding box 905) around the object of interest included in an environment that may be viewed using a device is provided in accordance with exemplary aspects of the present disclosure. A device (e.g., AR device 15) may determine the gaze of an eye(s) of the user (e.g., the user looking at a robot in the environment). Based on the determined object(s) of interest of the user, the device may implement a gaze analysis component (e.g., gaze analysis component 117, gaze analysis component 313, or gaze analysis component 407) to generate a segmentation mask (e.g., segmentation mask 909, denoted by the dashed outline of the robot 901 of FIG. 11A) of the object of interest in a bounding region (e.g., bounding box 905). The segmentation mask (e.g., segmentation mask 909) may match the pixels (e.g., exact pixels) of the object of interest (e.g., the mask may include only the object of interest by removing all other content from the environment other than the object of interest (e.g., a robot 901).

In response to generating the segmentation mask (e.g., segmentation mask 909), the gaze analysis component of the device may generate a segmented image (e.g., image 913) from the environment based on the determined object of interest (e.g., a robot 901). In some examples, the segmented image 913 may include (only) the object of interest (e.g., a robot 901) over a background that may be chosen/selected by the gaze analysis component to be neutral and distinct from the object of interest (e.g., a colorful object of interest may be placed over a white background or a black background, etc.). In response to a question (e.g., a question by a user such as e.g., “What is it?”), the MMAI model of the gaze analysis model may generate an answer to the question such as description 921 (e.g., “This appears to be a robot on a black background”). The description 921 may be presented with the segmented image 913 and may be viewable by the user in the field of view (e.g., camera 124, front camera(s) 416) of the device.

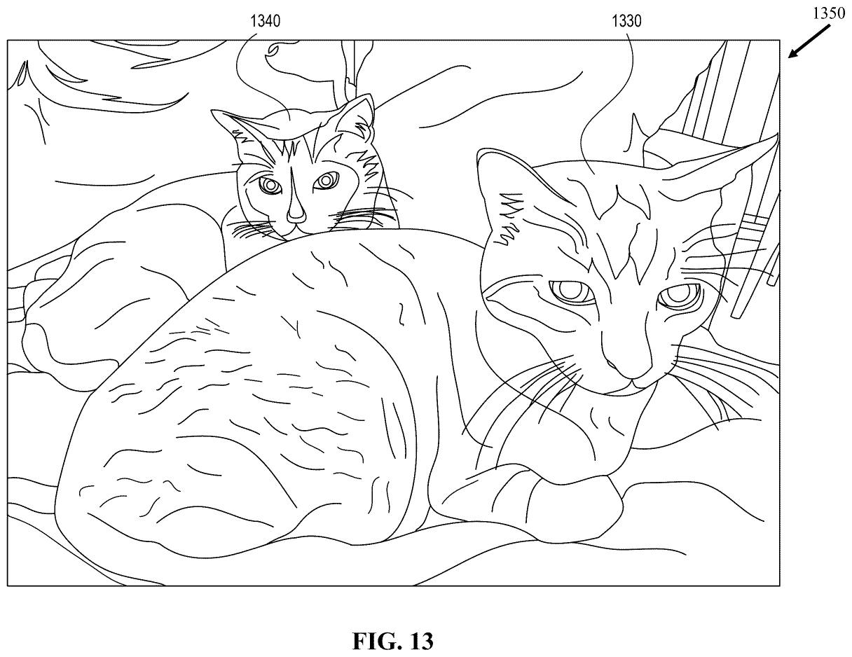

Referring to FIG. 13, a diagram illustrating an environment is provided in accordance with exemplary aspects of the present disclosure. In FIG. 13, environment 1350 may include a cat 1330 and a cat 1340. In an example, cat 1330 may have orange fur, while cat 1340 may have brown and black fur with white spots on its ears, paws, and tail. In an example, a user 10 may be viewing environment 1350 using an AR device 15. User 10 may use a voice prompt, by asking, “What color is this cat?” while looking at cat 1340. The voice prompt may cause/trigger the AR device 15 to determine that user 10 is requesting a photo/image capture of an object of interest in the environment. Upon recognition that user 10 is requesting a photo/image capture, the AR device 15 may determine a gaze of an eye(s) (e.g., eye 12) of a user (e.g., user 10) looking at/viewing the cat 1340.

In some examples, the AR device 15 may implement a gaze analysis component (e.g., gaze analysis component 117, gaze analysis component 313, gaze analysis component 407, or gaze analysis component 507) to determine that the gaze of the eye(s) of the user is directed at cat 1340. The AR device 15 may then implement the gaze analysis component to generate a bounding region (e.g., a bounding box) around cat 1340. The bounding region may be any shape(s) that may include cat 1340 within the region (e.g., in some instances the bounding region may include content other than the image of the cat 1340). The gaze analysis component may utilize the cropping technique(s) of the example aspects of the present disclosure described above to generate an image of the content of/within the bounding region (e.g., an image of cat 1340 in the example of FIG. 13). In an example, the AR device 15 may implement the gaze analysis component to analyze the contents of the generated cropped image. Analysis of the cropped image may enable AR device 15 to provide information about the cropped image. As an example, in response to the user's (e.g., user 10) question about the color of the cat, the AR device 15 may respond with an answer such as, “the cat is brown and black with white spots on its ears, paw, and tail.” In some examples, the generated answer by the AR device may be presented to the user along with the image of the cat 1340, for example in a field of view (e.g., of a camera 124, front camera(s) 416, image sensor 502, or a display 414) of the AR device.

In another example aspect of the present disclosure that uses the segmentation technique(s) described above, in response to the bounding region (e.g., the bounding box) being generated, the AR device 15 may implement the gaze analysis component to generate a segmentation mask of the image of the cat 1340. The segmentation mask may match the pixels (e.g., exact pixels) of the cat 1340 (e.g., the mask may include only cat 1340). The AR device 15 may then generate an image of the content of the segmentation mask (e.g., an image of cat 1340) with a neutral and distinct background. The gaze analysis component may then analyze the image of cat 1340 for analysis and generate an answer user's (e.g., user 10) question about cat 1340 (e.g., the cat is brown and black with white spots on its ears, paw, and tail).

FIG. 15 illustrates an example flowchart process 1500 illustrating operations for analysis of an object of interest according to an example of the present disclosure. At operation 1502, a device (e.g., UE 100, computing system 300, HMD 410, HMD 500) may determine a gaze of an eye of a user based on the user viewing, by a communication device, content items in an environment. At operation 1504, a device (e.g., UE 100, computing system 300, HMD 410, HMD 500) may capture a first image of an object(s) of interest to the user from among the content items in the environment.

At operation 1506, a device (e.g., UE 100, computing system 300, HMD 410, HMD 500) may generate a bounding region (e.g., bounding box 905) around the object(s) of interest. At operation 1508, a device (e.g., UE 100, computing system 300, HMD 410, HMD 500) may remove, by a machine learning model, items of data associated with objects other than the object(s) of interest from the bounding region to generate a second image. In some examples, the machine learning model may be machine learning model(s) 910. At operation 1510, a device (e.g., UE 100, computing system 300, HMD 410, HMD 500) may determine, based on removing of the items of data, items of information about the object(s) of interest.

In some examples, the device may generate the bounding region by selecting pixels of the object(s) of interest in the bounding region while excluding pixels of the items of data associated with the objects from the bounding region. The device may exclude the pixels of the items of data associated with the objects from the bounding region by using a segmentation mask (e.g., segmentation mask 909). In some examples, the device may generate the bounding region by cropping an image of the object(s) of interest from the first image and excluding a subset of content in the bounding region (e.g., bounding box 905) other than the object(s) of interest.

The device may determine that the excluding of the subset of content in the bounding region increases/enhances the accuracy of a description (e.g., descriptions 917, 919, 921) of the object(s) of interest associated with the determining of the items of information about the object(s) of interest. The items of information about the object(s) of interest may describe the object(s) of interest or one or more attributes of the content items in the environment (e.g., a real world environment and/or a virtual reality environment). The device may determine that the items of information about the object(s) of interest is in response to a query by the user inquiring about a description of the object(s) of interest.

Additionally, the device may determine the gaze of the eye of the user satisfying (e.g., equaling or exceeding) a predetermined threshold automatically triggers the capturing of the first image of the object(s) of interest and the determining of the items of information about the object(s) of interest. The device may present, by a display device (e.g., display/touchpad/user interface(s) 112, display 307, display 414, display 508) of, or associated with, the device, the determined items of information about the object(s) of interest.

The device may output, by an audio device (e.g., speaker/microphone 108, audio device 406, image sensor(s) 502), audio content associated with a synthesized voice (e.g., a computer generated voice) indicating the determined items of information about the object(s) of interest. The device may be smart glasses (e.g., artificial reality system 400), a head-mounted display device (e.g., HMD 500), or other types of devices (e.g., UE 100, computer system 300).

The exemplary aspects of the present disclosure may provide a system and method to facilitate analysis of an object of interest based on a gaze. The system may implement a machine learning model including training data pre-trained, or trained in real-time, on content associated with one or more gazes of a user. The system may determine a gaze(s) of an eye(s) of the user. The system may determine an object(s) of interest of the user based on the gaze(s). The system may implement the machine learning model to generate a bounding region around the object(s) of interest. The system may generate an image of the content of the bounding region. The system may analyze the content of the generated image.

### ALTERNATIVE EMBODIMENTS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
determining a gaze of an eye of a user based on the user viewing, by a communication device, content items in an environment;
capturing a first image of an object of interest to the user from among the content items in the environment;
generating a bounding region around the object of interest;
removing, by a machine learning model, items of data associated with objects other than the object of interest from the bounding region to generate a second image; and
determining, based on the removing of the items of data, items of information about the object of interest.

2. The method of claim 1, wherein:
generating the bounding region comprises selecting pixels of the object of interest in the bounding region while excluding pixels of the items of data associated with the objects from the bounding region.

3. The method of claim 1, wherein:
generating the bounding region comprises cropping an image of the object of interest from the first image and excluding a subset of content in the bounding region other than the object of interest.

4. The method of claim 3, further comprising:
determining that the excluding the subset of content in the bounding region increases accuracy of a description of the object of interest associated with the determining of the items of information about the object of interest.

5. The method of claim 1, wherein the items of information about the object of interest describes the object of interest or one or more attributes of the content items in the environment.

6. The method of claim 1, wherein:
determining of the items of information about the object of interest is in response to a query by the user inquiring about a description of the object of interest.

7. The method of claim 1, wherein:
determining the gaze of the eye of the user satisfying a predetermined threshold automatically triggers the capturing of the first image of the object of interest and the determining of the items of information about the object of interest.

8. The method of claim 1, further comprising:
presenting, by a display device of the communication device, the determined items of information about the object of interest.

9. The method of claim 1, further comprising:
outputting, by an audio device of the communication device, audio content associated with a synthesized voice indicating the determined items of information about the object of interest.

10. The method of claim 1, wherein:
the communication device comprises smart glasses or a head-mounted display device.

11. An apparatus comprising:
one or more processors; and
at least one memory storing instructions, that when executed by the one or more processors, cause the apparatus to:
determine a gaze of an eye of a user based on the user viewing, by the apparatus, content items in an environment;
capture a first image of an object of interest to the user from among the content items in the environment;
generate a bounding region around the object of interest;
remove, by a machine learning model, items of data associated with objects other than the object of interest from the bounding region to generate a second image; and
determine, based on the removing of the items of data, items of information about the object of interest.

12. The apparatus of claim 11, wherein when the one or more processors further execute the instructions, the apparatus is configured to:
generate the bounding region by selecting pixels of the object of interest in the bounding region while excluding pixels of the items of data associated with the objects from the bounding region.

13. The apparatus of claim 11, wherein when the one or more processors further execute the instructions, the apparatus is configured to:
generate the bounding region by cropping an image of the object of interest from the first image and excluding a subset of content in the bounding region other than the object of interest.

14. The apparatus of claim 13, wherein when the one or more processors further execute the instructions, the apparatus is configured to:
determine that the excluding the subset of content in the bounding region increases accuracy of a description of the object of interest associated with the determine of the items of information about the object of interest.

15. The apparatus of claim 11, wherein the items of information about the object of interest describes the object of interest or one or more attributes of the content items in the environment.

16. The apparatus of claim 11, wherein when the one or more processors further execute the instructions, the apparatus is configured to:
determine the items of information about the object of interest in response to a query by the user inquiring about a description of the object of interest.

17. The apparatus of claim 11, wherein when the one or more processors further execute the instructions, the apparatus is configured to:
determine the gaze of the eye of the user satisfying a predetermined threshold automatically triggers the capture of the first image of the object of interest and the determine of the items of information about the object of interest.

18. The apparatus of claim 11, wherein the apparatus comprises smart glasses or a head-mounted display device.

19. A non-transitory computer-readable medium storing instructions that, when executed, cause:
determining a gaze of an eye of a user based on the user viewing, by a communication device, content items in an environment;
capturing a first image of an object of interest to the user from among the content items in the environment;
generating a bounding region around the object of interest;
removing, by a machine learning model, items of data associated with objects other than the object of interest from the bounding region to generate a second image; and
determining, based on the removing of the items of data, items of information about the object of interest.

20. The computer-readable medium of claim 19, wherein the instructions, when executed, further cause:
generating the bounding region by selecting pixels of the object of interest in the bounding region while excluding pixels of the items of data associated with the objects from the bounding region.
